(19) United States
(12) Patent Application Publication
(10) Pub. No.: US 2026/0063225 A1
(43) Pub. Date: Mar. 5, 2026

(54) Pipeline Sealing Assembly with Pipeline Sleeve and Pipeline Terminals and Method of Making Same

(71) Applicant: LPS IP, LLC, Rancho Cucamonga, CA (US)

(72) Inventors: Jose Anisio de Oliveira e Silva, Belo Horizonte (BR); Ryan Michael Sears, Costa Mesa, CA (US)

(21) Appl. No.: 19/106,628

(22) PCT Filed: Aug. 30, 2023
(86) PCT No.: PCT/US2023/031575

§ 371 Date: Feb. 25, 2025

Related U.S. Application Data
(60) Provisional application No. 63/402,381, filed on Aug. 30, 2022.

(51) Int. Cl. F16L 9/14

(52) U.S. Cl. CPC F16L 9/14

(57) ABSTRACT

A pipeline assembly and methods for assembling a pipeline. The pipeline assembly is for forming a seal about a pipeline having pipeline pipes connected together with a passage to receive fluids therethrough. The pipeline assembly includes a pipeline sleeve and pipeline terminals. The pipeline sleeve includes a sleeve support and a sleeve liner. The sleeve liner has an outer liner surface with a sleeve pocket shaped to receivingly support the sleeve support. The pipeline terminals include a terminal liner and terminal belt. The terminal belt is lockably secured into position between an outer terminal surface of the terminal liner and an inner pipeline surface of the pipeline whereby the pipeline sleeve is lockingly and sealingly secured about the pipeline pipes. A terminal tube may also be provided between the pipeline pipes to support the pipeline sleeve and pipeline terminals.

### CROSS-REFERENCE TO RELATED APPLICATIONS

This application is the national stage filing of PCT/US2023/031575 filed on Aug. 30, 2023, which claims the benefit of U.S. Provisional Application No. 63/402,381 filed on Aug. 30, 2022, both of which are hereby entirely incorporated by reference herein.

### BACKGROUND

The present disclosure relates generally to pipelines. In particular, the present disclosure relates to sealing techniques for use in pipelines.

Pipelines are used to transport fluids between locations. The pipelines may be formed from a series of tubulars connected together to form a fluid passage for flow of the fluids therethrough. The tubulars may be connected together by connections, such as threads. Examples of connections are provided in Patent/Application Nos. WO2022/03 1 767, WO2022/03 1769, WO2014/164862, WO2019/041016, US2007284872, US2006145479, US2005225089, U.S. Pat. Nos. 8,596,692, 7,431,341, 6,357,802, and 5,346,261, the entire contents of which are hereby incorporated by reference herein. To assure good connection between the connected tubulars, the tubulars and the connections may be secured by welds, bonds, or adhesives. Examples are provided in Patent/Application Nos. US2004070199, U.S. Pat. Nos. 6,719,186, 5,984,370, 5,779,276, 5,584,512, 5,566,986, 5,566,984, 9,599,257, 9,909,695, WO2014/164862, WO2019/041016, and PCT/BR2018/050315, the entire contents of which are hereby incorporated by reference herein.

Despite advancements in pipeline technology, there remains a need for effective and efficient techniques for sealing pipelines, and that such techniques allow for ease of manufacture, assembly, and operation.

### SUMMARY

In at least one aspect, the disclosure relates to a pipeline assembly for forming a seal about a pipeline. The pipeline has pipeline pipes connected together with a passage to receive fluids therethrough. The pipeline assembly comprises a pipeline sleeve and a pipeline terminal. The pipeline sleeve is positionable in the passage of the pipeline to form a pipeline seal therewith. The pipeline sleeve comprises a sleeve support and a sleeve liner. The sleeve support has tubular shape with an outer sleeve surface shaped to conform to an inner pipeline surface of the pipeline. The sleeve liner is positionable in the passage of the pipeline. The sleeve liner has a tubular shape. The sleeve liner has an outer liner surface with a sleeve pocket extending therein. The sleeve pocket is shaped to receivingly support the sleeve support. A portion of the outer liner surface of the sleeve liner is sealingly engageable with the inner pipeline surface of the pipeline. The sleeve liner has sealing ends on each end thereof. The pipeline terminals each comprise a terminal liner and a terminal belt. The terminal liner is positionable in the passage of the pipeline. The terminal liner has a tubular shape with an outer terminal surface engageable with the inner pipeline surface of the pipeline. The terminal liner has a sleeve end and an open end. The sleeve end is sealingly engageable with the sealing end of the sleeve liner. The terminal belt is positioned about the terminal liner. The terminal belt is lockably secured into position between the outer terminal surface of the terminal liner and the inner pipeline surface of the pipeline whereby the pipeline sleeve is lockingly and sealingly secured about the pipeline pipes.

In another aspect, the disclosure relates to a method of forming a pipeline assembly. The method comprises assembling a first loaded pipeline pipe by: a) positioning a terminal belt about a terminal liner to form a belted liner; and b) inserting the belted liner into a pipeline pipe; assembling a second loaded pipeline pipe by repeating a)-b); inserting a first sleeve end of a pipeline sleeve into a first contact end of the first loaded pipeline pipes; inserting a second sleeve end of the pipeline sleeve into a second contact end of the second loaded pipeline pipe; and connecting the first contact end of the first loaded pipeline pipe to the second contact end of the second loaded pipeline pipe.

In yet another aspect the disclosure relates to a method of assembling a pipeline. The method comprises assembling a pipeline assembly by: a) assembling a tube assembly by connecting terminal tubes to a first pipeline end and a second pipeline end of a pipeline pipe; and b) assembling a liner assembly by: assembling a belted liner by connecting a terminal belt to a first liner end of a terminal liner; inserting a first belted end of the belted liner into the first pipeline end of the pipeline pipe and advancing the liner assembly into the pipeline pipe until a second belted end of the belted liner extends from the second pipeline end of the pipeline pipe; connecting a second terminal belt to a second liner end of the belted liner; and retracting the belted liner into the pipeline pipe; forming another pipeline assembly by repeating a) and b); inserting a first portion of a pipeline sleeve into the first pipeline end of a first of the pipeline pipes and inserting a second portion of the pipeline sleeve into the second pipeline end of a second of the pipeline pipes; and connecting the first pipeline end of the first of the pipeline pipes and the second pipeline end of the second pipeline pipe.

In at least one aspect, the disclosure relates to a pipeline sleeve, comprising: a sleeve support; sleeve sealers; and a sleeve liner. The sleeve sealers may be seals or gaskets. The sleeve support may comprise: an inner sleeve; an outer sleeve; ring spacers; and a flex layer. The flex layer and the ring spacers are positioned between the inner sleeve and the outer sleeve.

In another aspect, the disclosure relates to a pipeline sealing assembly, comprising: a pair of pipeline pipes; a pipe liner; a pair of pipeline terminals; a pair of belted liners, and a pipeline sleeve. The belted liner comprises a terminal liner and a terminal belt.

The disclosure also relates to a belted liner for a pipeline, the belted liner comprising: a terminal liner and a terminal belt.

The disclosure also relates to a pipeline sealing assembly, a pipeline terminal, a belted liner, and a pipeline sleeve as described herein.

Finally, in another aspect, the disclosure relates to a method of assembling a pipeline comprising: sealingly connecting a pair of pipeline pipes together by: connecting a pipeline terminal to a pipe end of each of pair of the pipeline pipes; positioning connecting ends of the pipeline terminals onto opposite ends of a pipeline sleeve; and connecting the connecting ends of the pipeline terminals together with the pipeline sleeve therein such that the pipeline sleeve forms a seal about the terminal ends. The method may further comprise inserting a liner into the pipeline pipe, the pipeline terminal, and the pipeline sleeve. The method may also comprise: assembling a pipe assembly, a pipeline sleeve, pipeline terminal, a tube assembly, a liner assembly, and/or a pipeline; and/or a method of sealing a pipeline. The disclosure also relates to a method of assembling and/or sealing a pipeline, a pipeline sleeve, a pipeline terminal, a tube assembly, a liner assembly, a pipe assembly, and/or a pipeline sealing assembly as described herein.

This Summary is not intended to be limiting and should be read in light of the entire disclosure including text, claims and figures herein.

### BRIEF DESCRIPTION OF THE DRAWINGS

So that the above recited features and advantages of the present disclosure can be understood in detail, a more particular description of the disclosure, briefly summarized above, may be had by reference to the embodiments thereof that are illustrated in the appended drawings. The appended drawings illustrate example embodiments and are, therefore, not to be considered limiting of its scope. The figures are not necessarily to scale and certain features, and certain views of the figures may be shown exaggerated in scale or in schematic in the interest of clarity and conciseness.

FIG. 1 is a schematic diagram depicting a pipeline comprising pipeline pipes with a pipeline sealing assembly including pipeline terminals and a pipeline sleeve.

FIG. 2 is a longitudinal, cross-sectional view of a portion 2 of the pipeline of FIG. 1 including the pipeline sealing assembly.

FIG. 3 is an exploded view of a portion 3 of the pipeline of FIG. 1 including the pipeline sealing assembly.

FIGS. 4A-4B are longitudinal, cross-sectional views of a portion 4 of the pipeline sealing assembly of FIG. 2 showing the pipeline sleeve in an uncompressed and compressed position, respectively.

FIGS. 4C-4D are longitudinal, cross-sectional views of a gasket version of the pipeline sealing assembly.

Figures SA-SE are schematic diagrams showing various views of a sleeve seal.

FIG. 6 is a schematic diagram depicting stages of assembly of the pipeline sleeve.

FIG. 7 is a longitudinal, cross-sectional view of a portion of the pipeline with another version of the pipeline sleeve having a sleeve seal with a T-shaped configuration.

FIGS. 8A-8B are longitudinal, cross-sectional views of a portion 8 of the pipeline of FIG. 7 showing the pipeline sleeve in an uncompressed and compressed position, respectively.

FIGS. 9A-9D are schematic diagrams showing various views of the T-shaped sleeve seal.

FIGS. 10A-10C are schematic diagrams depicting another version of the pipeline sleeve positioned in merged pipeline pipes.

FIGS. 11A-11E show various views of a belted liner.

FIG. 11F1 is a longitudinal, cross-sectional view of a portion of the pipeline with a constant diameter terminal and a constant diameter belted liner.

FIG. 11F2-11F3 are exploded and perspective views, respectively of the constant diameter belted liner.

FIGS. 12A-12B are end and side views, respectively, of a terminal belt.

FIGS. 13A-13B are schematic perspective diagrams depicting stages of assembly of portions of the pipeline.

FIGS. 14A-14B are schematic cross-sectional diagrams depicting stages of assembly of the portions of the pipeline.

FIG. 15 is a flow chart a depicting a method of assembling a pipeline.

FIG. 16 is a longitudinal, cross-sectional view of another version of the pipeline sealing assembly in a direct configuration.

FIG. 17 is an exploded view of the pipeline of FIG. 16.

FIG. 18 is another longitudinal, cross-sectional view of the direct pipeline sealing assembly.

FIGS. 19A and 19B are longitudinal, cross-sectional and exploded views, respectively, of a pipeline sleeve of the direct pipeline sealing assembly.

FIG. 20 is a schematic diagram depicting stages of assembly of the pipeline sleeve of FIG. 16.

FIG. 21 is a longitudinal, cross-sectional view of a portion of the pipeline with another version of the direct pipeline assembly.

FIGS. 22A and 22B are detailed views of portions of the pipeline of FIG. 21.

FIGS. 23A and 23B are longitudinal, cross-sectional, schematic views of portions of the pipeline sealing assembly of FIG. 16.

FIG. 24 is a partial longitudinal, cross-sectional view of a pipeline pipe with the internal terminal therein.

FIGS. 25A and 25B are exploded perspective and cross-sectional views, respectively, of the internal terminal.

FIGS. 26A-26b are cross-sectional and perspective views, respectively, of an internal terminal belt with a flat configuration.

FIGS. 27A-27D are various views of another internal terminal belt with a pitch configuration.

FIGS. 28A and 28B are schematic perspective diagrams depicting stages of assembly of portions of the pipeline.

FIGS. 29A and 29B are schematic cross-sectional diagrams depicting stages of assembly of the portions of the pipeline.

### DETAILED DESCRIPTION

The description that follows includes exemplary apparatus, methods, techniques, and/or instruction sequences that embody techniques of the present subject matter. However, it is understood that the described embodiments may be practiced without these specific details.

The present disclosure relates to a pipeline sealing assembly for forming a seal about portions of the pipeline. The pipeline may include a series of pipeline pipes connected end to end with a passage for the flow of fluid therethrough. The pipeline sealing assembly may be positioned between adjacent and abutting pipeline pipes to form a pipeline seal thereabout. The pipeline sealing assembly may include a pipeline sleeve and pipeline terminals. The pipeline terminals may be connected to the ends of adjacent pipeline pipes, and abuttingly joined together. The pipeline sleeve may be positioned in the pipeline terminals to form a seal therewith. A supported liner may extend through the pipeline pipes, the pipeline terminals, and the pipeline sleeve.

The pipeline terminals may be used to provide additional support to the ends of the pipeline pipes and to provide a stronger surface for connection between the pipeline pipes. The pipeline terminals may receive a terminal liner inside. The terminal liner may have a terminal belt to secure and/or support the terminal liner within the pipeline terminals. The terminal belt may also provide additional support against the pipeline sleeve, thereby assisting the pipeline sleeve in maintaining a seal about portions of the pipeline terminals and/or the pipeline.

The pipeline sleeve may extend across adjoining pipeline terminals to form a seal therein. The pipeline sleeve includes a pipeline support and pipeline seals. The pipeline support may be positioned adjacent adjoining ends of the pipeline terminals to provide mechanical, insulative, and/or sealing support thereabout. Sealers (sleeve seals), such as seals, gaskets, a-rings, etc., may also be provided in the pipeline sleeve to further provide fluid isolation about the adjoining pipeline terminals. The pipeline sleeve may also have a liner therein.

The pipeline and one or more of its components (e.g., the pipeline terminals, the pipeline sleeve, the liner, etc.) may also be provided with one or more of the following capabilities, among others: ease of manufacture, ease of assembly, efficient operation, lower assembly cost, cost effective assembly and/or use, reinforced sealing, sealing capabilities in even high and/or extreme pressure conditions, and operability with existing systems and/or equipment, dimensions that can be tailored to fit various configurations, prevention of leakage and/or corrosion, adjustability for various tolerances, shaped to mold to and/or sealingly engage surfaces of the pipeline (e.g., the pipeline pipes, the pipeline terminals, the pipeline sleeve), etc.

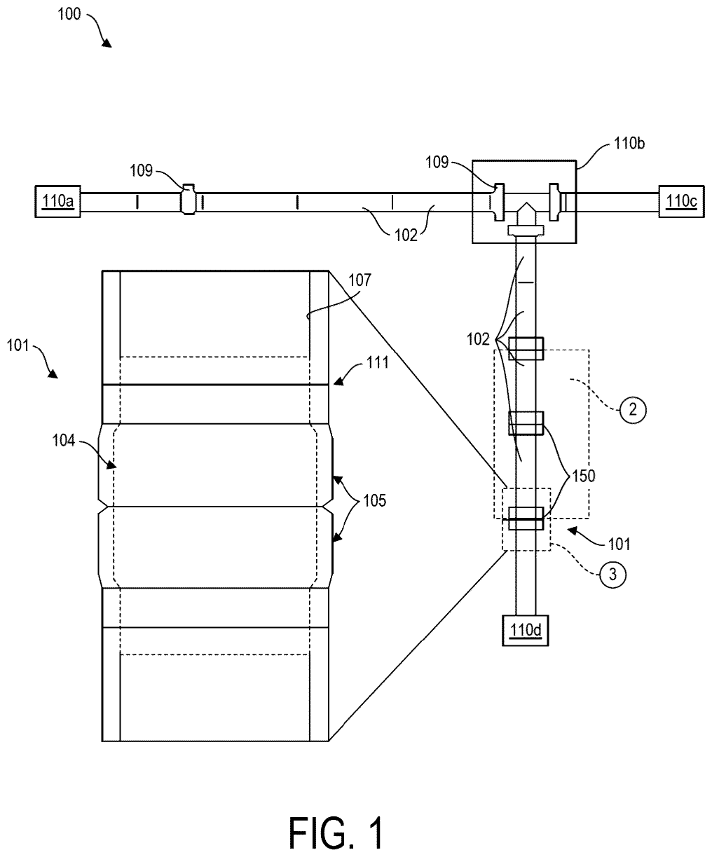

FIG. 1 is a schematic diagram depicting a pipeline 100 comprising pipeline pipes 102 with a pipeline sealing assembly 101 including pipeline terminals 105 and a pipeline sleeve 104. This figure shows an example of a pipeline system including facilities 110a-d with the pipeline pipes 102 extending therebetween. In the example shown, the facilities 110a-d include a production facility 110a, a beneficiation facility 110b, a market 110c, and a tailings disposal 110d. The pipeline pipes 102 extend from the production facility 110a, through the beneficiation facility 110b, and to the market 110c.

A portion of the pipeline 100 branches off at the beneficiation facility 110b and extends to the tailings disposal 110d. Supports 109 may optionally be provided along the pipeline 100 to support the pipeline pipes 102. A passage 107 extends through each of the pipeline pipes 102 to define a pathway for the passage of fluids (e.g., oil, gas, water, etc.) between the facilities 110a-d.

The pipeline 100 may be a continuous, monolithic piping system or include individual, connected sections of the pipeline pipes 102. As shown in FIG. 1, the pipeline 100 includes a series of the pipeline pipes 102 connected together end to end in series to form the pipeline 100. Adjacent pairs of the pipeline pipes 102 may be joined together by various means capable of securing the pipeline pipes 102 together. The pipeline 100 may be formed, for example, by attaching a connector (such as an external joint or an internal sleeve) across an adjacent pair of the pipeline pipes 102, by applying a weld to ends of adjacent pairs of the pipeline pipes 102, and/or by threading ends of the adjacent pairs of the pipeline pipes 102 together. Examples of techniques for connecting pipes or other tubulars are described in the patent/application(s) previously incorporated by reference herein.

The pipeline pipes 102 may be provided with various devices, such as the pipeline sealing assembly 101. The pipeline sealing assembly 101 may be positioned between the adjacent pairs of the pipeline pipes 102 to form a sealed and supportive connection therebetween. In this example, the pipeline sleeve 104 is positioned within adjacent ends of the pipeline terminals 105. The pipeline terminals 105 are secured between the adjacent pipeline pipes 102 with the pipeline sleeve 104 therein to form a pipeline seal 111 therewith.

To form the pipeline 100, certain sections of the pipeline 100 and the pipeline sealing assembly 101 may be pre-assembled. For example, one or more pipeline pipes 102 with a pipeline terminal 105 at one or both ends may be pre-assembled to form a pipe assembly 150 for connection with additional portions of the pipeline 100 as described further herein.

It will be appreciated that different configurations of the pipeline 100 and its components may be used. For example, the pipeline 100, the pipeline pipes 102, and/or the pipeline sealing assembly 101 may be provided with various features, such as welds, threads, connectors, sleeves, supports, and seals, to facilitate connection and/or sealing about the pipeline 100 as described further herein. While several examples of configurations that may be used are described, these are not intended to be limiting of the features of the disclosed pipeline sealing assemblies, the pipeline terminals, and/or the pipeline sleeves described herein.

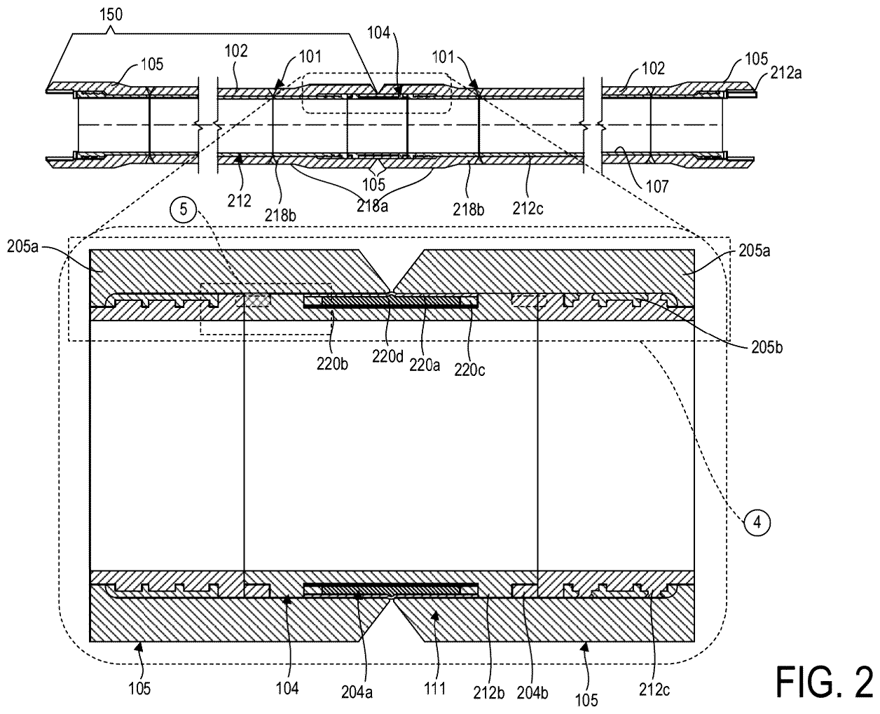

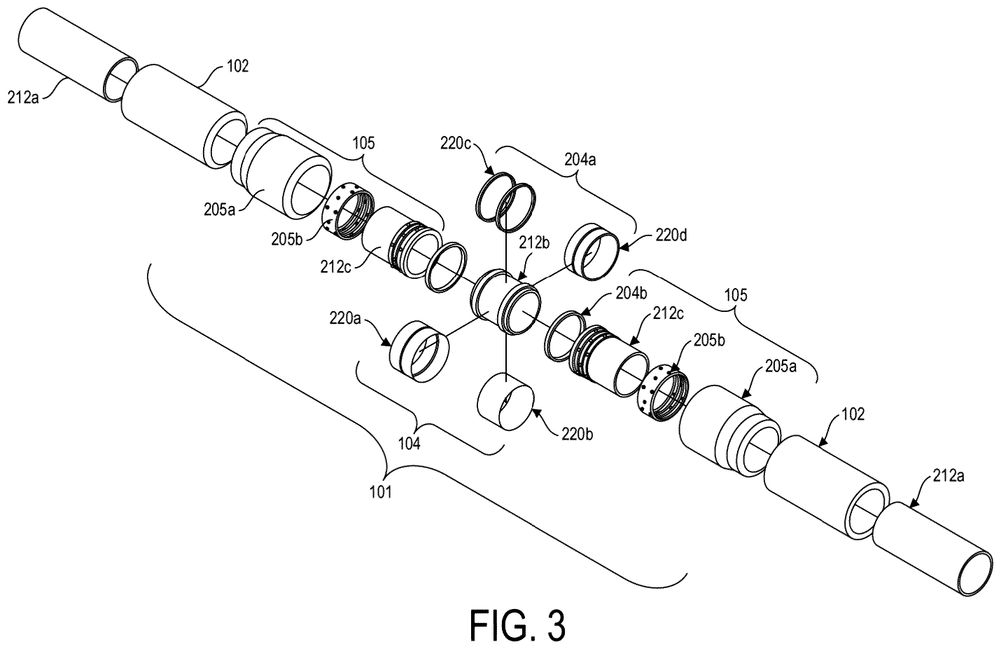

FIGS. 2 and 3 show various views of the pipeline sealing assembly 101 including the pipeline sleeve 104 and the pipeline terminals 105. FIG. 2 is a longitudinal, cross-sectional view of a portion 2 of the pipeline 100 of FIG. 1 including the pipeline sealing assembly 101. FIG. 3 is an exploded view of a portion 3 of the pipeline 100 of FIG. 1 including the pipeline sealing assembly 101.

The pipeline sealing assembly 1 0 1 may be connected between various sets of pipeline pipes 102. The pipeline pipes 102 are metal tubulars having the passage 107 therethrough. One or more of the pipeline pipes 102 may be axially aligned to form a series of pipeline pipes 102 for connection with other pipeline pipes 102 and/or with the pipeline sealing assembly 101. In the example shown in FIG. 2, an adjacent pair of the pipeline pipes 102 are connected together with the pipeline sealing assembly 101 therebetween. As described further herein, prior to connection of the between portions of the pipeline sealing assembly 101, one or more of the pipeline pipes I 02 may be pre-assembled with one or more of the pipeline terminals 105 to form the pipe assembly 150.

As shown in FIGS. 2 and 3, the pipeline sleeve 104 is connectable between adjacent pairs of the pipeline terminals 105 to form the pipeline seal 111. The pipeline sealing assembly 101 includes the pair of pipeline terminals 105 connected together and positioned between the pair of pipeline pipes 102, with the pipeline sleeve 104 positioned within the abuttingly adjoined pipeline terminals 105. Additional pipeline terminals 105 may also be provided at non-adjacent ends of the pipeline pipes 102 for connection to additional portions of the pipeline 100 of FIG. 1.

Referring still to FIGS. 2 and 3, the passage 107 extends through each of the pipeline pipes 102, the pipeline terminals 105, and the pipeline sleeve 104 to permit substantially uninterrupted flow of fluid therethrough. Portions of the pipeline 100 may be provided with a liner 212 along the passage 107 for protection (e.g., from fluids passing therethrough). As shown in examples herein, the liner 212 includes a pipe liner 212a positioned along the inner surface of the pipeline pipes 102, a sleeve liner 212b positioned along an inner surface of the pipeline sleeve 104, and a terminal liner 212c positioned along an inner surface of the pipeline terminals 105. The liner 212 may extend over all or only a portion of these inner surfaces. Various components may be positioned between the liner 212 and the respective inner surface as described further herein.

The liner 212 may be made of a wear or corrosion resistant material, such as a liquid epoxy, fusion bonded epoxy, polyurethane, or any other material that provides a protective layer. Such a liner may be in the form of a pipe coating (lining) applied (e.g., sprayed) along an inner surface for protection, or in the form of a tubular member insertable into the passage 107. The liner 212 may also be applied by inserting, injecting, molding, attaching or otherwise positioning the liner 212 within the pipeline pipes 102, the pipeline sleeve 104, and/or the terminal tubes 105a. The liner 212 may be of any size or shape as needed to protect, seal, and/or allow fluids to pass therethrough. For example, the liner 212 may have a thickness (or gauge) as needed (more or less) to provide the sealing and support capabilities of the pipeline sealing assemblies described herein.

The liner 212 may also be a solid, tubular member insertable into the passage 107 along the inner surface of the pipeline pipes 102, the pipeline terminals 105, and the pipeline sleeve 104. The tubular liner 212 may be in the form of a unitary piece, multiple separate pieces, or multiple pieces adjoined together before or after insertion into the passage 107 of one or more portions of the pipeline pipes 102, the pipeline terminals 105, and/or the pipeline sleeve 104. One or more portions of the liners described herein may be adjoined together by various techniques, such as welding, bonding, thermo-fusion, electro-fusion, etc. The liner(s) 212 may be formed, for example, by machine or mold to achieve the desired shape. Examples of techniques for lining pipes are described in the patent/applications incorporated by reference herein.

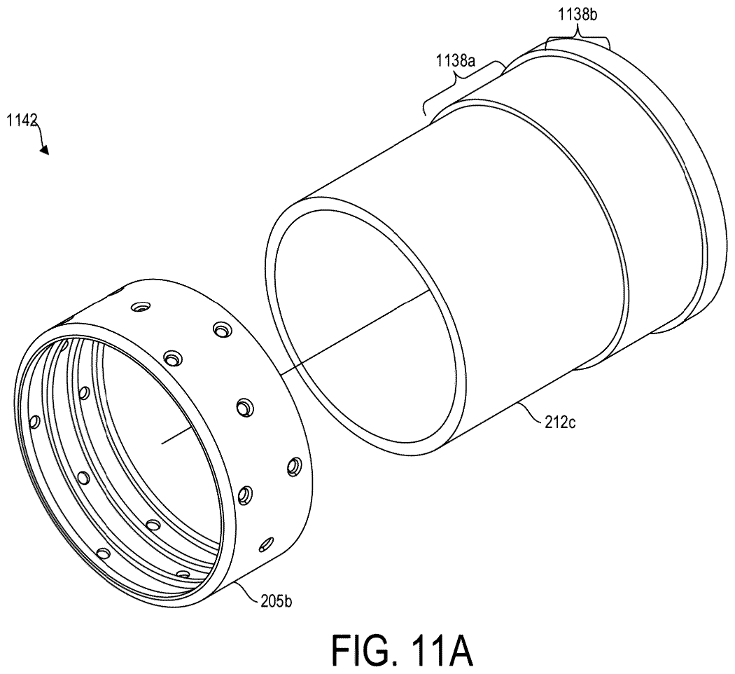

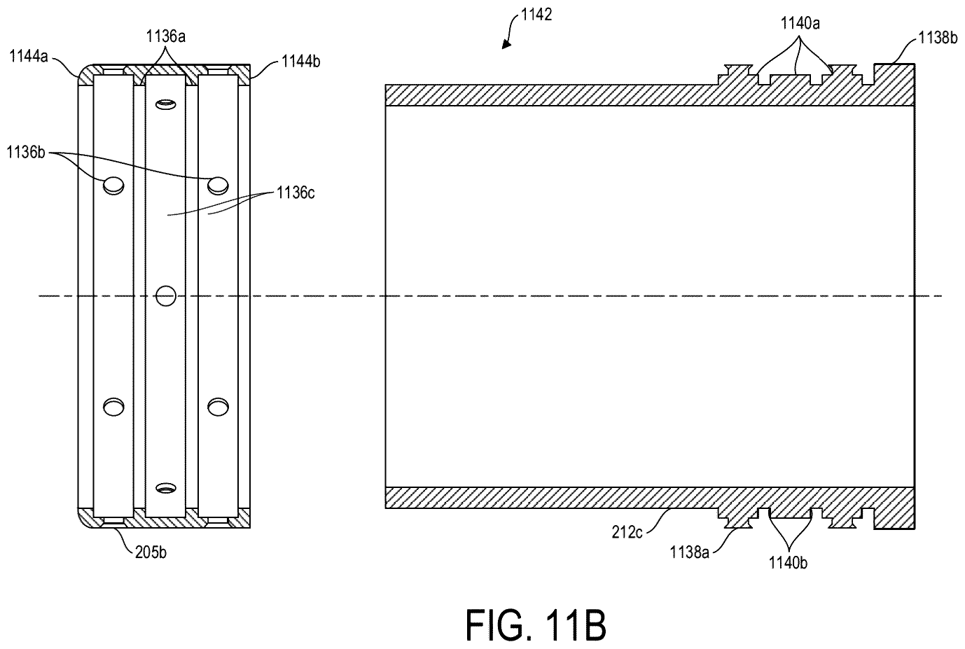

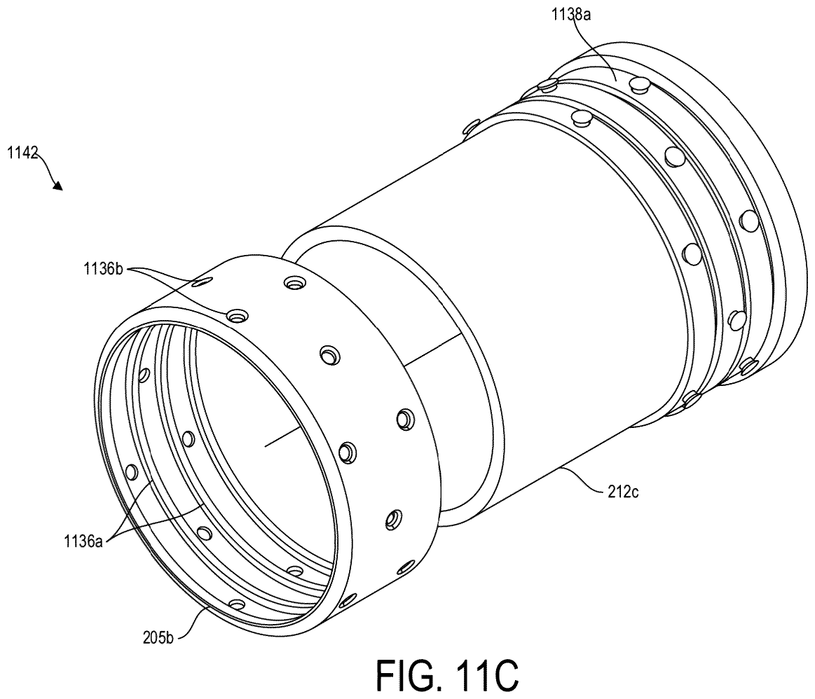

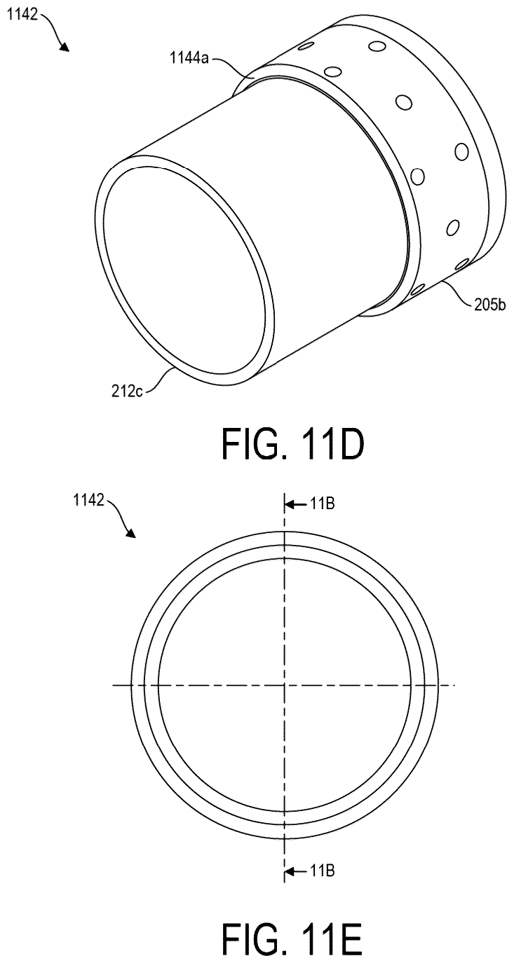

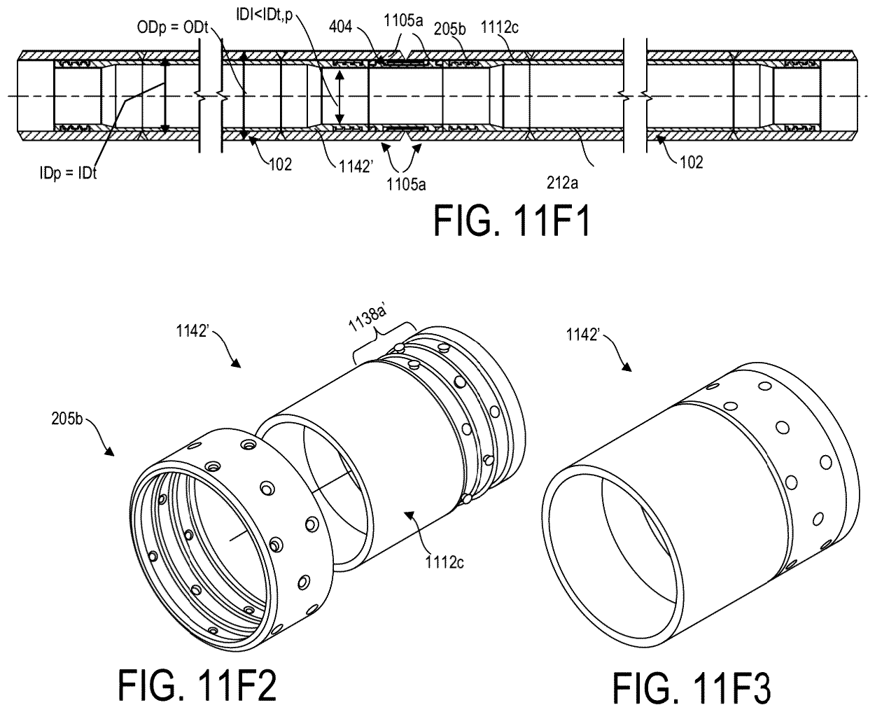

Each of the pipeline terminals 105 may be a terminal assembly including a terminal tube 205a, a terminal belt 205b, and the terminal liner 212c. Like the pipeline pipes 102, the terminal tube 205a may be a tubular member made of a strong material, such as steel, alloy, or other metal. The terminal tube(s) 205a may be connected to, or formed integrally with, the pipeline pipes 102. The terminal tube(s) 205a may be formed by modifying a pipeline pipe 102. For example, as shown in FIGS. 1 and 2, an end of a pipeline pipe 102 may be expanded, enlarged, upset, and/or machined to provide an engagement (terminal) end 218a with a larger inner and outer diameter than the remainder of the terminal tube 205a. As described further herein with respect to FIGS. 11F1-11F3, configurations may be provided where the terminal tube(s) 205a are formed with constant inner and outer diameters similar to those of the pipeline pipes 102.

Referring still to FIGS. 2 and 3, each of the terminal tubes 205a has a connection end 218b matingly connectable with an end of the pipeline pipe 102 and the engagement end 218a for engagement with the engagement end 218a of another terminal tube 205a. The connection ends 218b may be shaped for connection to the corresponding pipeline pipe 102. The connection end 218b may be matingly connected (e.g., threaded, fitted, welded, etc.) to the pipeline pipe 102.

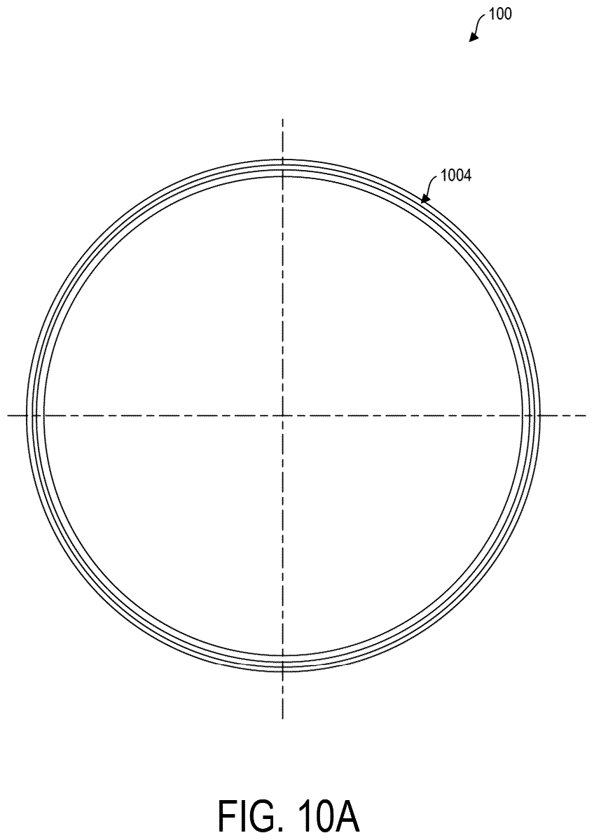

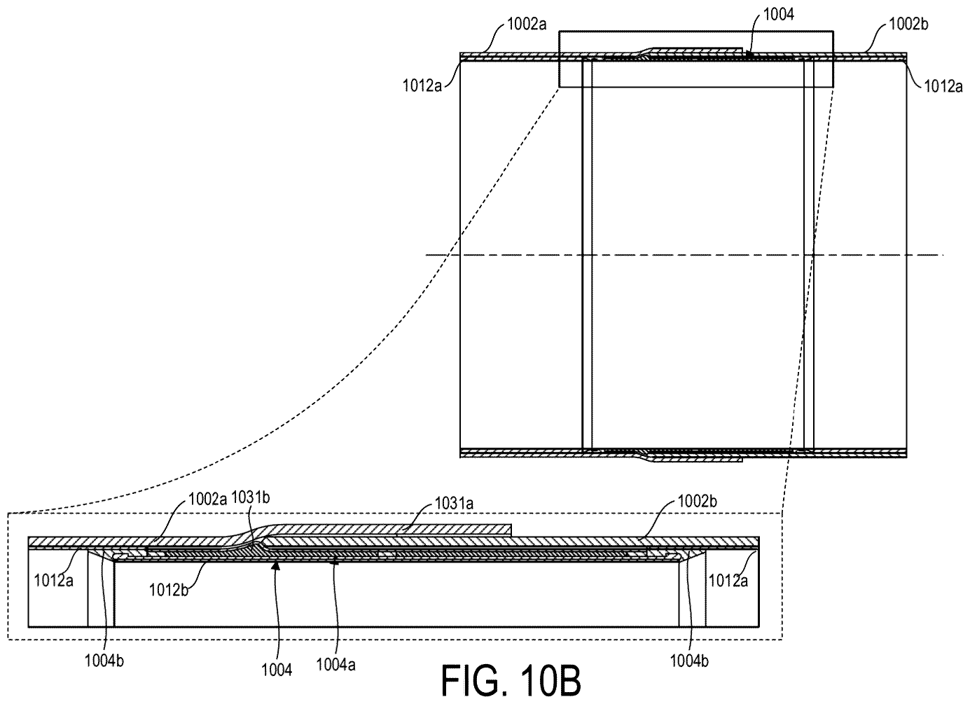

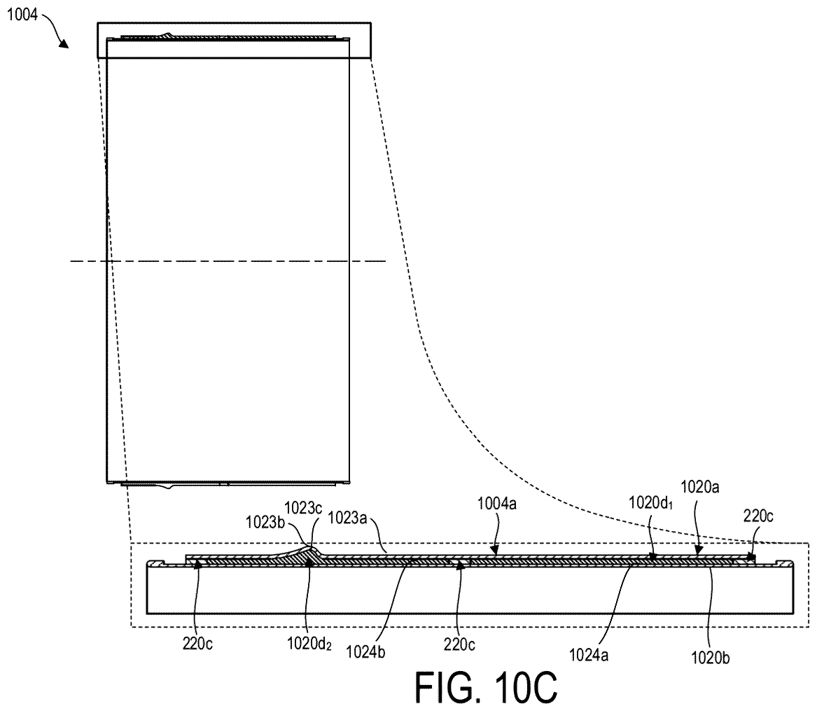

The pipeline pipes 102 with the terminal tubes 205a thereon may be axially aligned such that the engagement ends 218a of the terminal tubes 205a align for engagement therebetween. As shown in FIG. 2, the engagement end 218a of adjacent terminal tubes 205a may be beveled for abutting engagement and connection with each other. The engagement ends 218a may also be provided with enlarged diameters for additional structural support and/or to facilitate connection. The engagement end 218a of the terminal tubes 205a may be abuttingly joined together by a connection means (e.g., weld, adhesive, etc. not shown). While the terminal tubes 205a are shown in abutting engagement, the terminal tubes 205a may optionally be connected using butt strap or other methods, such as where the ends the pipeline terminals overlap as described further herein with respect to FIGS. 10A-10C.

The terminal liner 212c may be a tubular member made of a material similar to the liner 212. The terminal liner 212c may be shaped to conform to the inner surface of the terminal tube 205a with the passage 107 extending through the terminal liner 212c. The terminal belt 205b may be a ring-shaped member positioned between the terminal liner 212c and the terminal tube 205a to provide support as described further herein.

Referring still to FIGS. 2 and 3, the pipeline sleeve 104 is a tubular member positioned in the passage 107 within the pipeline terminals 105. The pipeline sleeve 104 may be axially aligned with the terminal tubes 205a and concentrically positioned therein. The pipeline sleeve 104 may be positioned along the inner surface of the terminal tubes 205a. The pipeline sleeve 104 may be shaped to fit snugly within the terminal tubes 205a to seal against the inner surface of the terminal tubes 205a. The pipeline sleeve 104 also extends across the adjoined engagement ends 218a of the pipeline terminals 105 to form the pipeline seal 111 thereabout.

The pipeline sleeve 104 is a sleeve assembly including a sleeve support 204a, sleeve sealers in the form of sleeve seals 204b, and the sleeve liner 212b. The sleeve support 204a extends across the engagement ends 218a of each of the terminal tubes 205a to provide support to the abutted engagement ends 218a of the terminal tubes 205. The terminal liner 212c is also concentrically positioned within the terminal tubes 205a and against the adjacent pipeline sleeve 104. The terminal liner 212c supports the pipeline sleeve 104 in position while also providing protection from fluids flowing through the pipeline sleeve 104. Each of the sleeve seals 204b are also positioned along the inner surface of a corresponding one of the terminal tubes 205a to form a seal about the engagement ends 218a of the terminal tubes 205a.

The sleeve support 204a includes an outer ring 220a, an inner ring 220b, ring spacers 220c, and a flex layer 220d as described further herein. The pipeline sleeve 104 may be partially or fully pre-assembled for insertion into and/or use with the pipeline pipes 102 as described further herein. When the pipeline sleeve 104 is inserted into the pipeline terminals 105, the outer ring 220a is positionable along the inner surface of the pipeline terminals 105. The pipeline sleeve 104 is insertable into the pipeline terminals 105 and extends across the engagement ends 218a of the terminal tubes 205a.

Once the pipeline sleeve 104 is installed in the pipeline terminals 105, the pipeline sleeve 104 may be urged into sealing engagement with the adjacent pipeline terminals 105 as is described further herein. This urging may result, for example, from pressure applied to the pipeline sleeve 104 as fluid passes therethrough. This pressure may place the pipeline sleeve 104 under compression against the inner walls of the terminal tubes 205a such that the sleeve seals 204b are compressed against the abutting end of the terminal liner 212c.

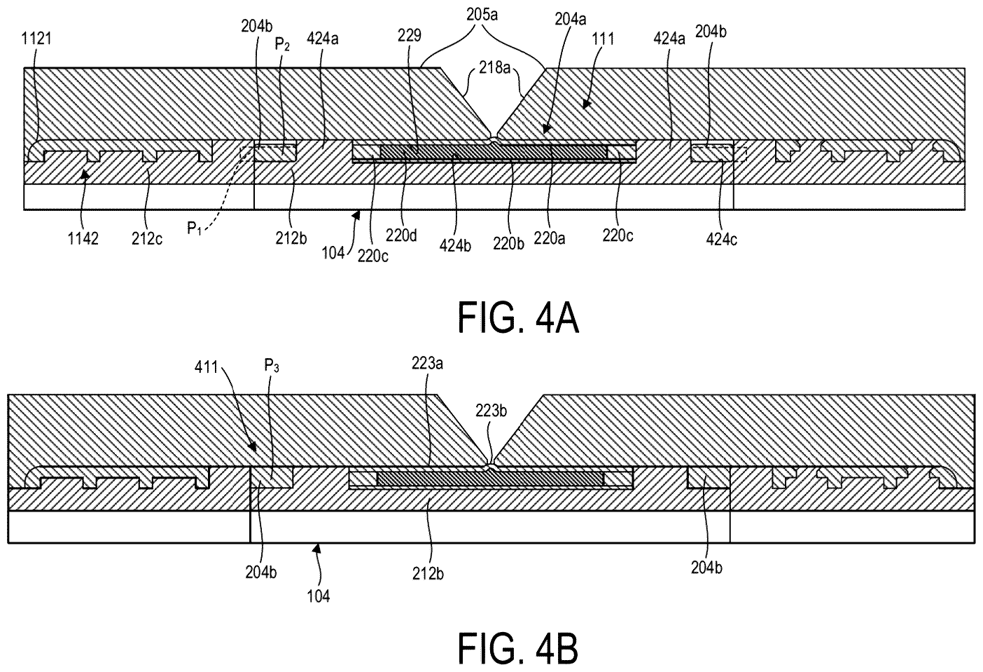

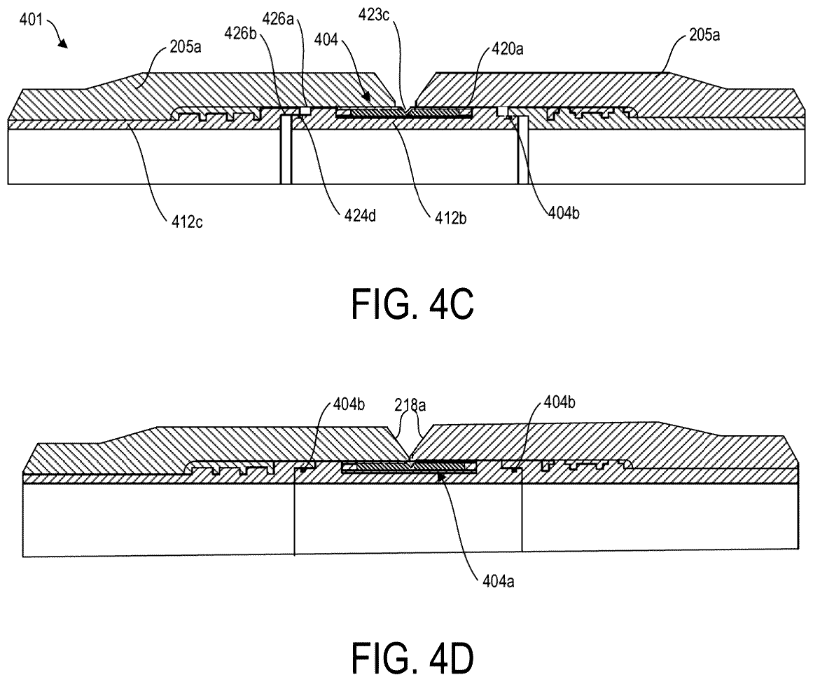

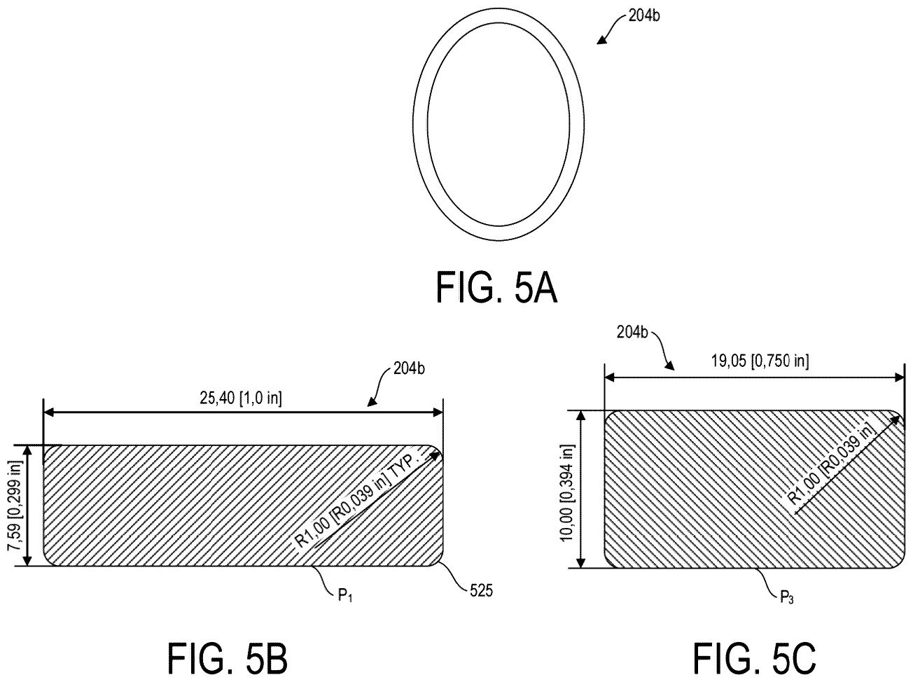

FIGS. 4A-4D show features of the pipeline sleeve 104,404 in greater detail. Referring first to FIGS. 4A and 4B, the pipeline sleeve 104 is shown in a seal configuration including the sleeve seals 204b. FIGS. 4A-4B are longitudinal, cross-sectional views of a portion 4 of the pipeline sealing assembly 101 of FIG. 2 showing the pipeline sleeve 104 in an uncompressed and compressed positions, respectively.

As shown by these views, when positioned in the abutted terminal tubes 205a, the pipeline sleeve 104 may be positioned to provide support to the terminal tubes 205a, and to form the pipeline seal 111 thereabout. The outer ring 220a and the inner ring 220b are tubular members concentrically positioned within the terminal tubes 205a. The outer ring 220a and the inner ring 220b may be a thin, metal tubular members. The outer ring 220a may have an outer surface shaped to conform to the inner surface of the terminal tubes 205a. The outer ring 220a may have a substantially smooth periphery 223a shaped to conform to and fit within the terminal tube 205a, and for engagement with the ring spacers 220c.

The outer ring 220a may be provided with a raised hump 223b. As also shown in FIGS. 4A and 4B, the raised hump 223b may have a symmetrical peak shape extending radially about a central periphery of the outer ring 220a. When the pipeline sleeve 104 is installed, the raised hump 223b may be positioned about the engagement ends 218a of the abutting terminal tubes 205a. Other shapes of pipeline sleeves 104 and various humps are described herein with respect to FIGS. 4C-4D and 1 0A-10C.

Referring still to FIGS. 4A and 4B, the inner ring 220b may fit within the outer ring 220a. The inner ring 220b may have the same width as and a smaller diameter than the outer ring 220a. The inner ring 220b may have a smooth, constant diameter without humps. The smaller diameter of the inner ring 220b may provide space between the outer ring 220a and the inner ring 220b.

Each of the ring spacers 220c are ring-shaped members are positioned in the space between the outer ring 220a and the inner ring 220b. The ring spacers 220c are flat ring-shaped members positioned flush with each and of the outer ring 220a and the inner ring 220b. The ring spacers 220c may be formed separately from, or integral with, the inner ring 220b. A flex cavity 229 is defined between the outer ring 220a, the inner ring 220b, and the ring spacers 220c. The flex cavity 229 is shaped to receive the flex layer 220d therein.

The flex layer 220d is also positioned in the space between the outer ring 220a and the inner ring 220b. The flex layer 220d may partially or fully fill the flex cavity 229. The flex layer 220d may be a flexible, uncompressible material, such as rubber, silicone, fiberglass, cellulose, ceramic, ceramic fiber, fiber, and/or other elastic and/or insulative material, capable of supporting the outer ring 220a and the inner ring 220b. The material of the flex layer may also provide heat protecting properties to protect the pipeline sleeve 104 during operations, such as welding.

The sleeve liner 212b may be a tubular shaped member positioned concentrically within the terminal tubes 205a. The sleeve liner 212b may be made of a protective material similar to the pipe liner 212a, and may be capable of protecting the pipeline sleeve 104, the sleeve support 204a, and the sleeve seals 204b. The sleeve liner 212b may be positioned (e.g., inserted, injected, molded, attached or otherwise positioned) within the sleeve support 204a along the inner surface of the inner ring 220b. The sleeve liner 212b may have a greater width than the inner ring 220b. The pipeline sleeve 104 may be positioned between the terminal liner 212c of each of the terminals tubes 205. Each end of the sleeve liner 212b may butt against an end of the terminal liner 212c of each of the pipeline terminals 105.

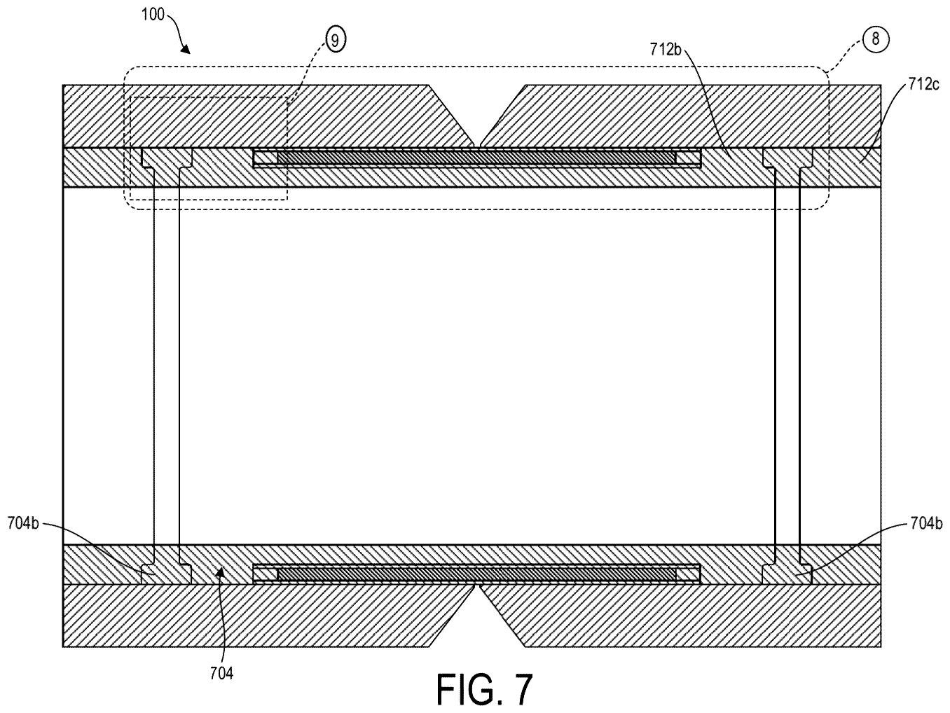

The sleeve support 204a and the sleeve seals 204b may be positioned between the sleeve liner 212b and the terminal tubes 205a. The sleeve liner 212b may also have raised portions 424a for engagement with the inner surface of the terminal tubes 205a. The raised portions 424a may be spaced apart and positioned a distance from each end of the sleeve liner 212b. The raised portions 424a may define a support pocket 424b therebetween shaped to receive the sleeve support 204a, and a seal pocket 424c shaped to receive the sleeve seals 204b. In the example shown, the support pocket 424b and the seal pocket 424c each have a rectangular pocket shape. Other pocket shapes can be provided as described further herein with respect to FIGS. 7-10C.

Referring still to FIGS. 4A and 4B, when the pipeline sleeve 104 is inserted into the pipeline pipes 102, the outer ring 220a and the flex layer 220d may be flexible for facilitating insertion of the pipeline sleeve 104 into the terminal tubes 205a. The outer ring 220a and the flex layer 220d may also be flexible for facilitating formation of the pipeline seal 111. The flex layer 220d may flex to accommodate the movement of the outer ring 220a. The outer ring 220a may compress against the flex layer 220d and press the flex layer 220d against the inner ring 220b. The flex layer 220d and the outer ring 220a may also apply a force against the terminal tubes 205a. This force may further enhance positioning and/or sealing about the pipeline sleeve 104 and the terminal tubes 205a.

As also shown by the seal configuration of FIGS. 4A and 4B, the sleeve seals 204b may have a shape defined to form the pipeline seal 111. The sleeve seals 204b may sealingly engage the terminal tubes 205a, the terminal liner 212c, and the sleeve liner 212b. Portions of the sleeve seal 204b may engage (e.g., contact and/or sealingly lock) and deform (e.g., flex, deflect, compress, etc.) with portions of the terminal tubes 205a and the pipeline sleeve 104 to prevent fluid leakage. Examples of sealing techniques and features may be found in the patents/applications previously incorporated by reference herein.

FIGS. 4A and 4B also show the sleeve seal 204b as it changes shape during use. In FIG. 4A, the sleeve seal 204b is schematically shown in the uninstalled position P1 before insertion into the seal pocket 424c, and the uncompressed position P2 after installation into the seal pocket 424c. In the uninstalled position P1, the sleeve seal 204b has an elongated rectangular shape. Once placed in the seal pocket 424c, the sleeve seal 204b is pinched between the sleeve liner 212b and the terminal liner 212c, and deforms to a narrower shape at position P2.

As shown in FIG. 4B, when a pressure change occurs, the pipeline sleeve 104 may compress and deform to the compressed position P3. In the compressed position P3, the sleeve seals 204b fill the seal pocket 424c and are urged against the terminal tubes 205a, the sleeve liner 212b, and the terminal liner 212c to form a liner seal 411 therewith. Under this compression, the sleeve seal 204b and other portions of the pipeline sleeve 104 and the pipeline terminal 105 may deform to form and/or enhance the pipeline seal 111.

FIGS. 4C-4D are longitudinal, cross-sectional views of a gasket (or o-ring) version of the pipeline sealing assembly 401. As demonstrated by these figures, various forms of sealing mechanisms and/or components of the pipeline sealing assembly 401 may be provided. This version of the pipeline sealing assembly 401 is similar to the pipeline sealing assembly 101, except that pipeline sleeve 404 has a sleeve sealer in the form of a gasket 404b (in place of the sleeve seal 204b). The gasket 404b may be a ring-shaped member made of a sealing material, such as an elastomer (e.g., rubber). The gasket 404b may be seated in the sleeve liner 412b. A sealer (gasket) pocket 424d may be positioned in the sleeve liner 412b, and shaped to receive the gasket 404b therein.

As also shown in FIGS. 4C-4D, the shape of the sleeve liner 412b and the terminal liner 412c may vary. In this example, the sleeve liner 412b and the terminal liner 412c have a stepped (or tongue and groove) configuration. The terminal liner 412c has a step (or lip) 426b and the sleeve liner 412b has a corresponding step 426a defining a receptacle shaped to receive the step 426b. When the pipeline sleeve 404 is inserted into the terminal tube 205, the step 426b of the sleeve liner 412b receivingly engages the step 426b for interlocking engagement between the sleeve liner 412b and the terminal liner 412c.

In the example shown, the gasket 404b is positioned between the sleeve liner 412b and the terminal liner 412c. The gasket 404b is positioned in the sealer pocket 424d along the step 426b for sealing engagement with the step 426a of the terminal liner 412c. While a stepped configuration is shown, a flat (or flush) configuration as shown in FIGS. 4A and 4B may also be used. The gasket(s) 404b may be positioned anywhere about the sleeve liner 212b and/or the terminal liner 212c to provide sealing engagement therebetween. While only one gasket 404b is shown, one or more of the sleeve seals 204b and/or the gasket(s) 404b may be positioned anywhere along the sleeve liner 212b and/or terminal liner 212c capable of providing sealing engagement between the sleeve liner 212b, the terminal liner 212c, and/or the terminal tubes 205a.

As also shown in FIGS. 4C and 4D, the pipeline sleeve 404 may include various configurations of the sleeve support 404a. In this example, a channel version of the pipeline sleeve 404 with an outer ring 420a having a channel (or inverted hump (peak)) 423c is used in place of the raised hump (peak) 223b of FIGS. 4A and 4B. The channel 423c in this version is positioned in a central position along the outer ring 420a about the adjacent engagement ends 218a of the terminal tubes 205. This channel 423c may provide a space about the adjacent engagement ends 218a to allow for the flow of material, such as molten welding or bonding materials, as the engagement ends 218a are secured together. This material may flow in such a way that the outer ring 420a does not become bonded to a weld root as the engagement ends 218a are secured together. Other configurations of pipeline sleeves and/or outer rings that may be used as described further herein (see, e.g., FIGS. 7A, SA-SB, and I 0A-I 0C).

FIGS. 5A-5E show example configurations of the sleeve seal 204b. As shown by these views the sleeve seal 204b may have various configurations to facilitate sealing. FIG. 5A is a perspective view of the sleeve seal 204b. FIGS. 5B and 5C are cross-sectional views of the sleeve seal 204b in the uninstalled position P1 and the compressed position P3, respectively. FIG. 5D shows positions P1 and P3 of the sleeve seal 204b of FIGS. 5B and 5C overlapped for comparison. FIG. 5E shows a portion 5 of the pipeline sleeve 104 of FIG. 2 with the overlapped sleeve seals 204b of FIG. 5D.

As also demonstrated by FIGS. 5A-5E, the sleeve seals 204b may be configured for sealing engagement with the terminal tubes 205a and/or the liners 212b,c. These figures also show the rectangular shape of the sleeve seals 204b and with rounded corners 525. FIGS. 5B and 5C also show example dimensions that may be used with the sleeve seals 204b. While these figures show specific features of the sleeve seal 204b, it will be appreciated that one or more other seal configurations may be positioned about the pipeline sleeve 104 for sealing between the pipeline sleeve 104 and each of the terminal tubes 205a.

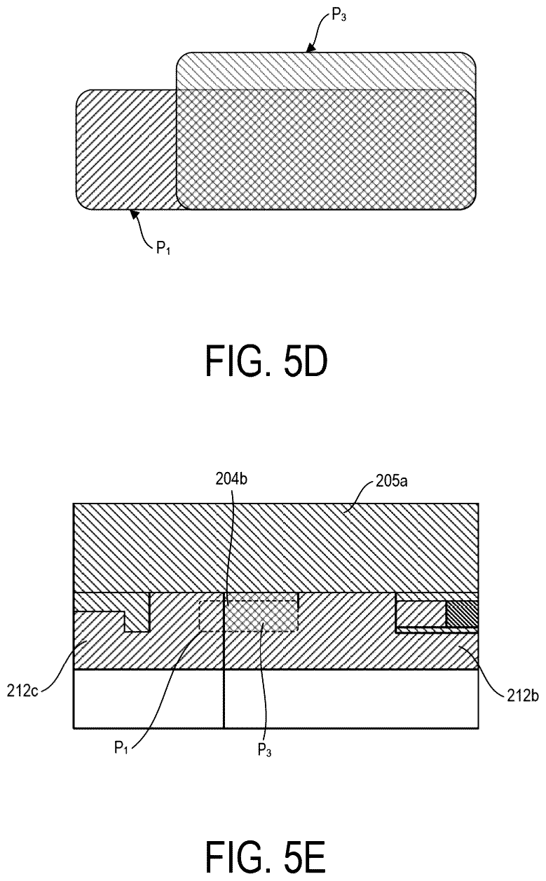

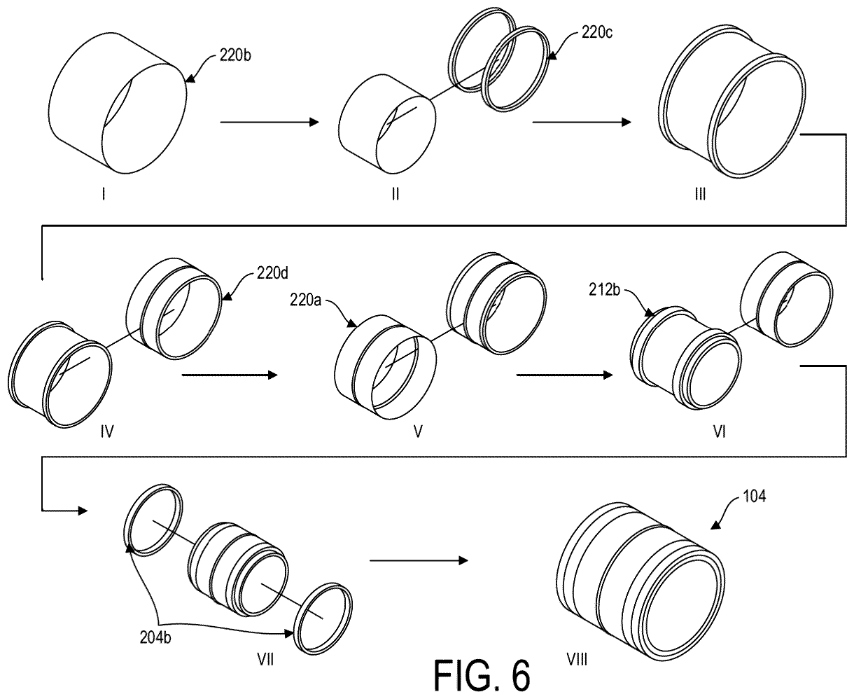

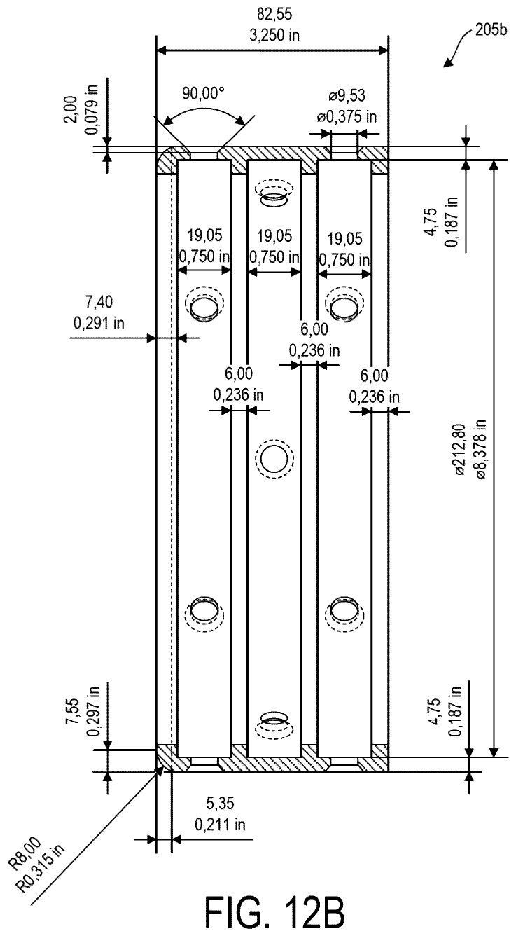

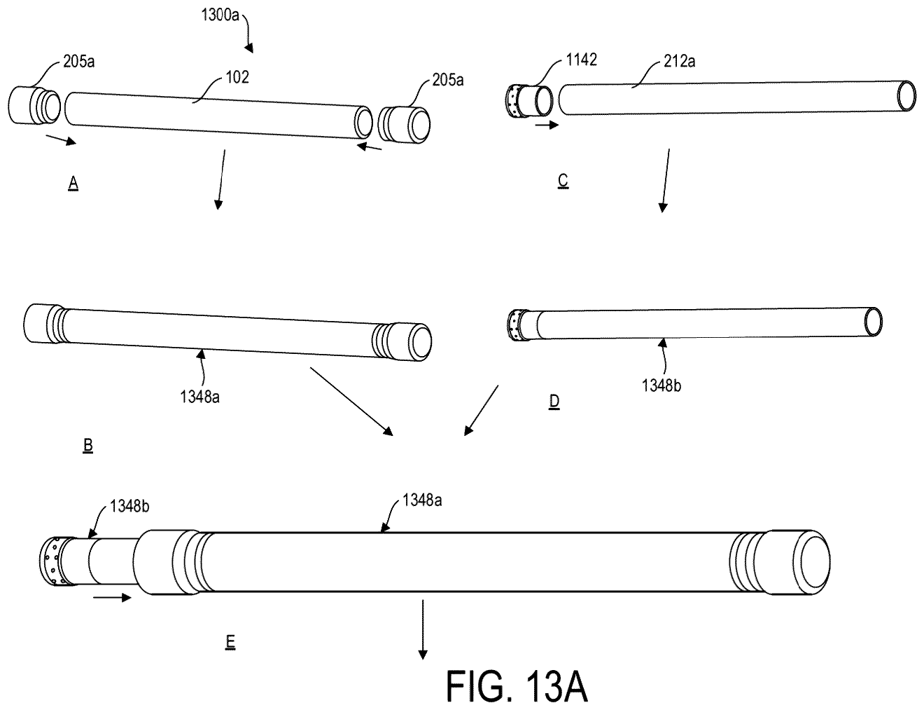

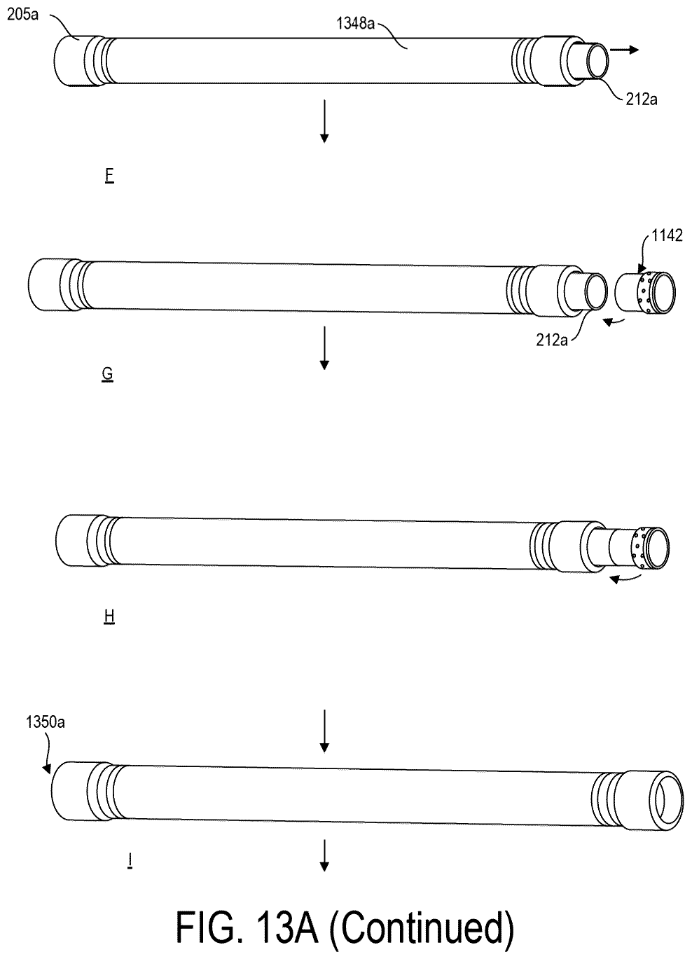

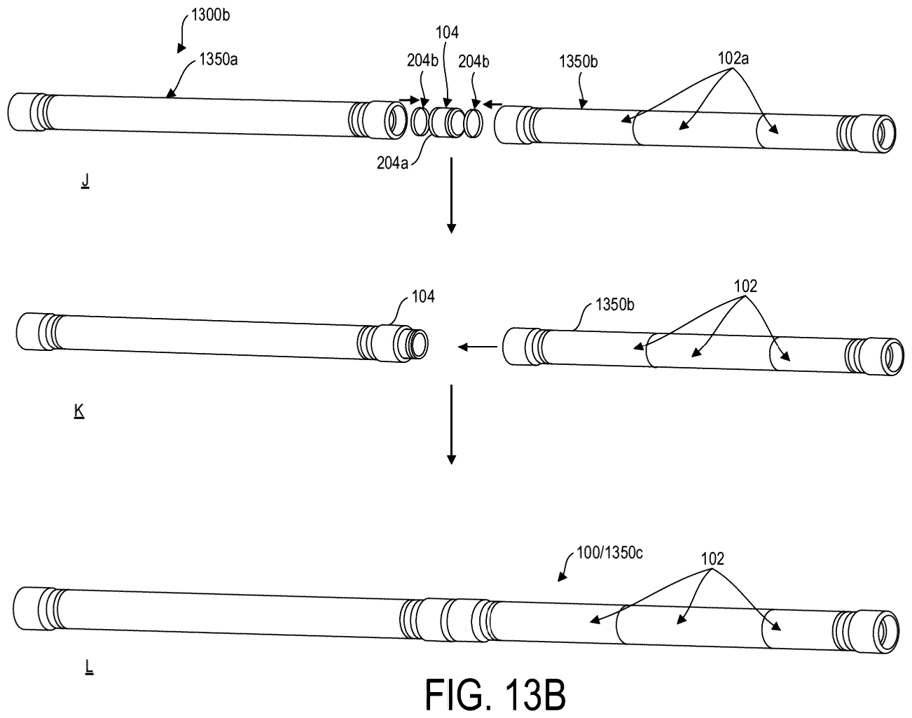

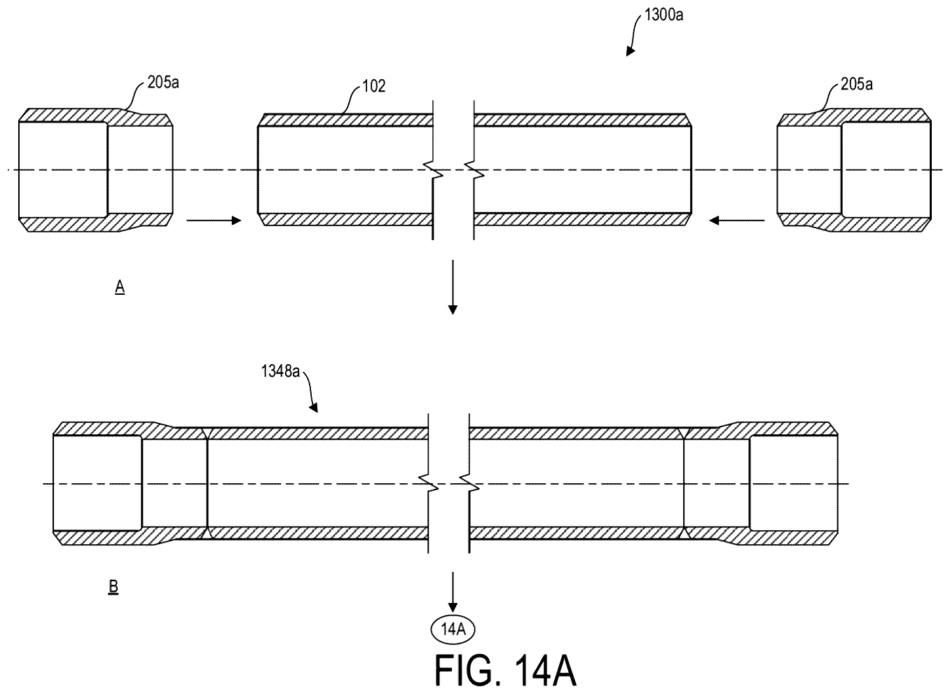

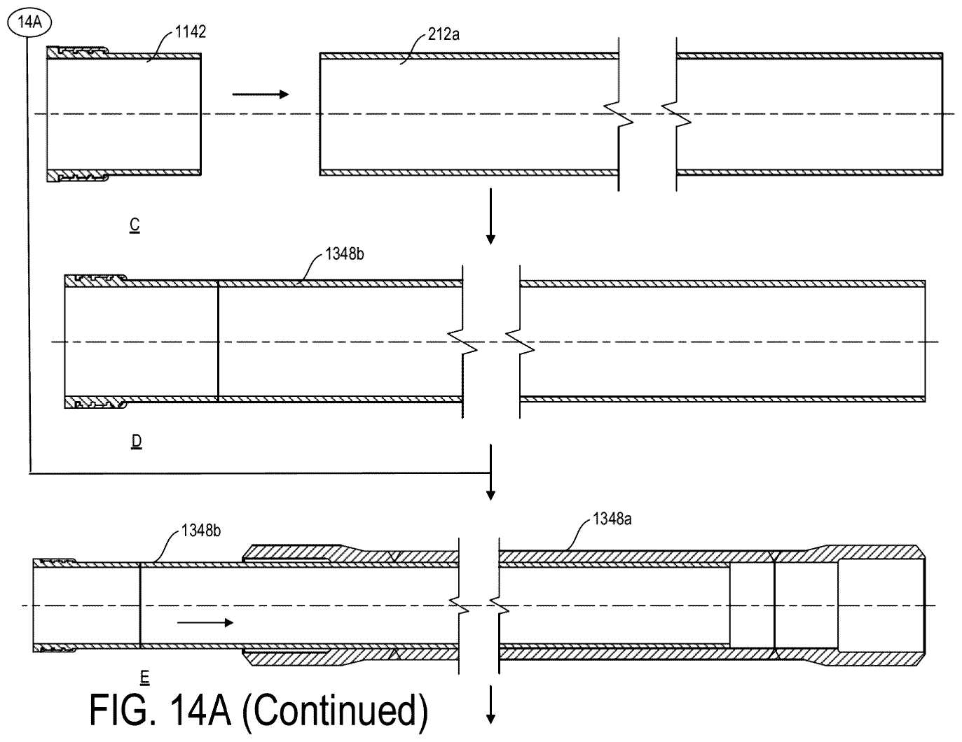

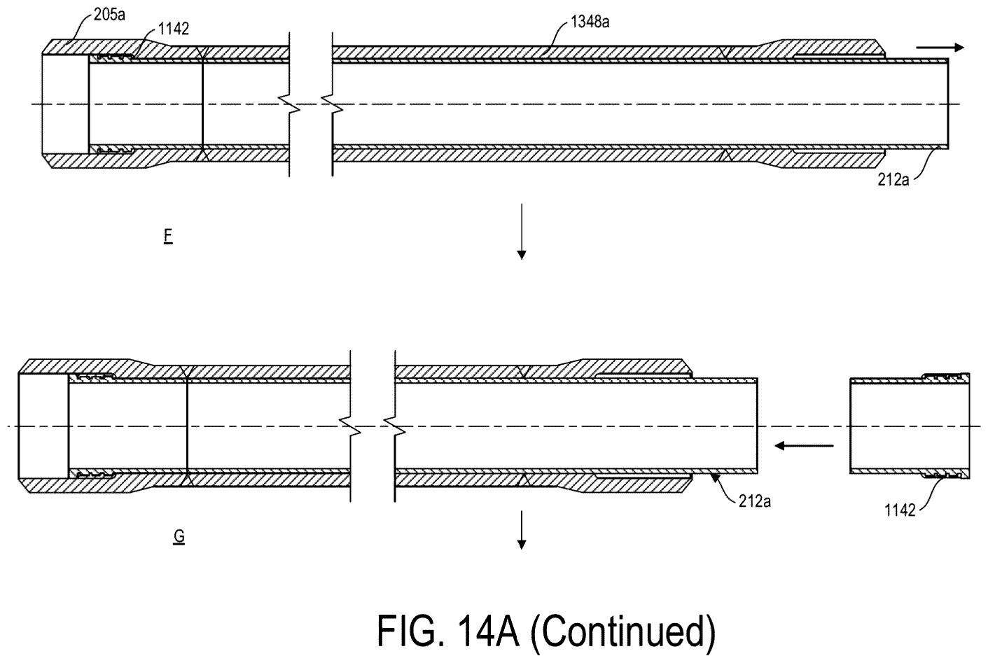

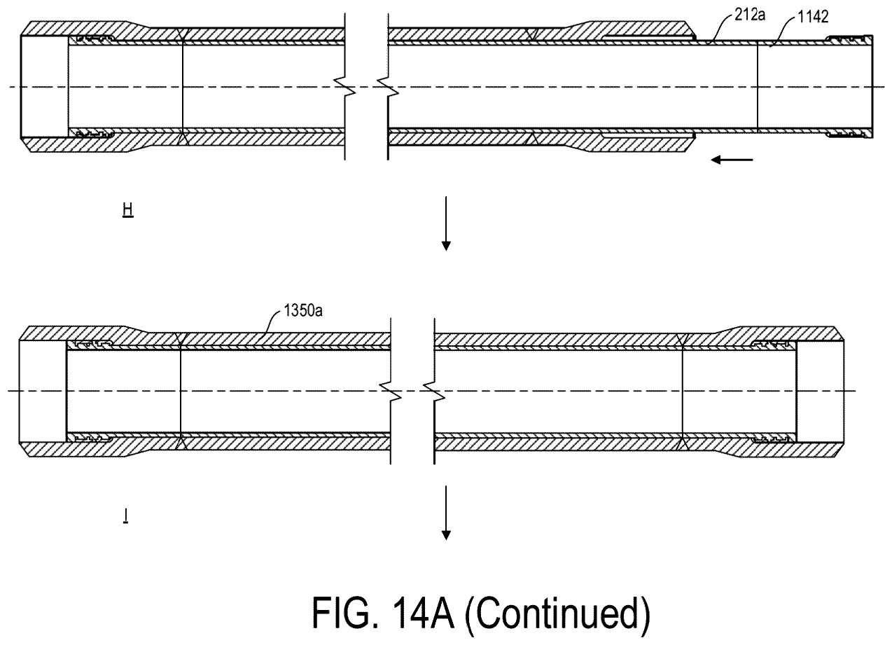

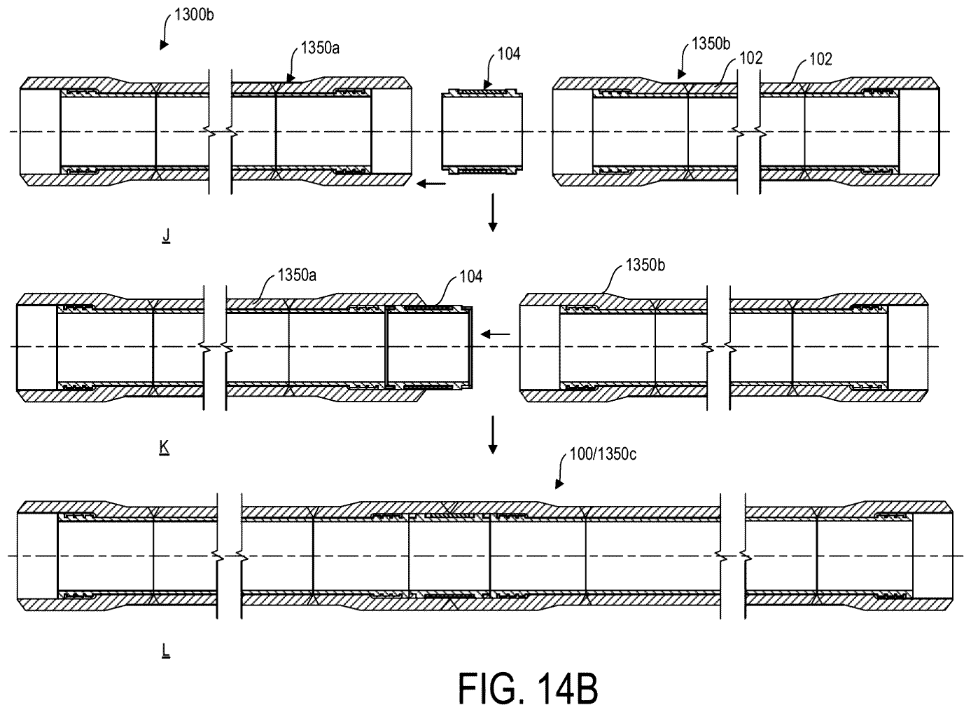

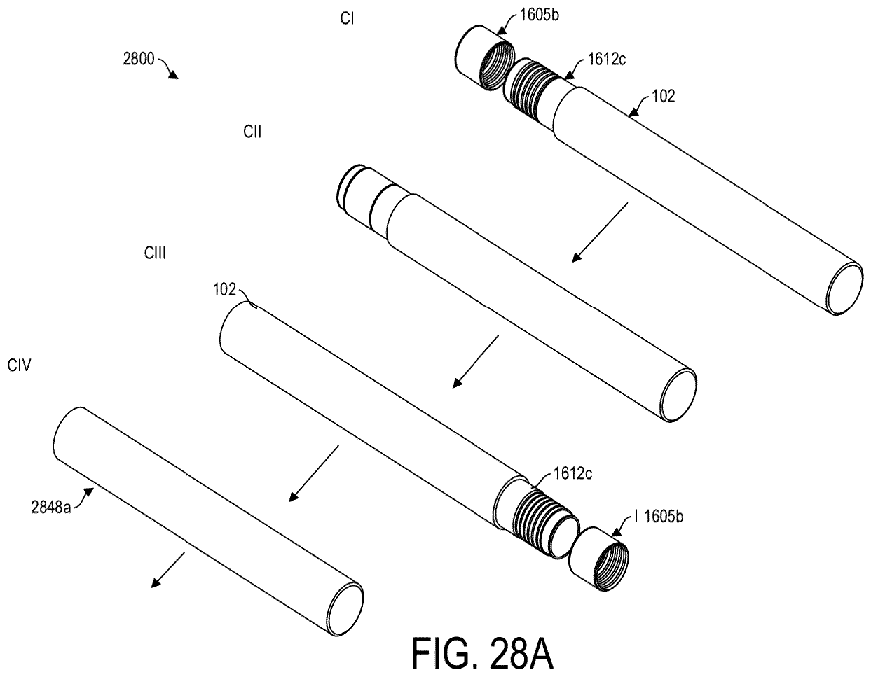

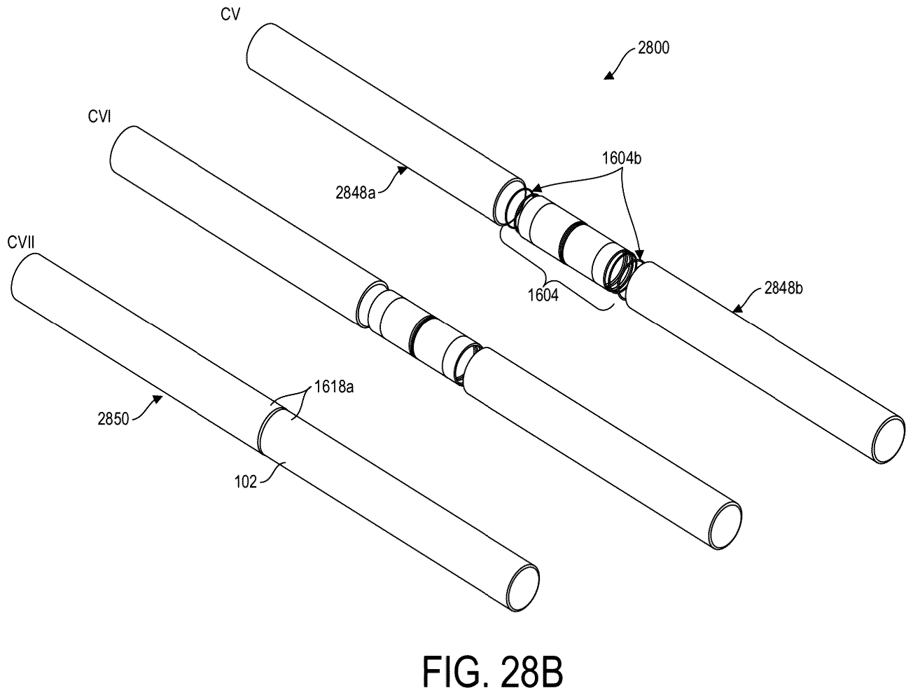

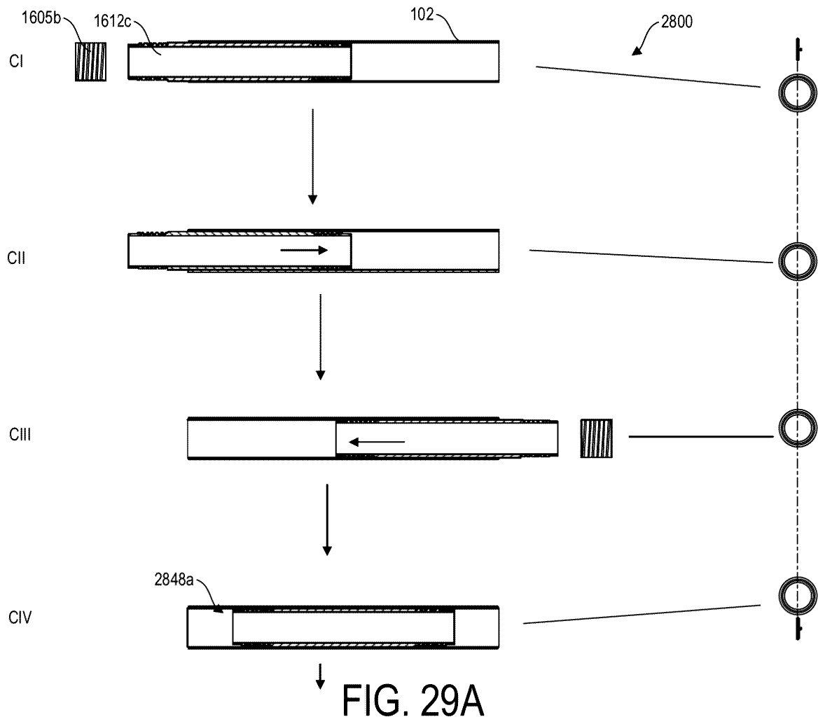

FIG. 6 is a schematic diagram depicting stages of assembly I-VIII of the pipeline sleeve 104. As demonstrated by FIG. 6, the pipeline sleeve 104 may be pre-assembled for delivery or on location. The pre-assembled pipeline sleeve 104 may then be inserted into the terminal tubes 205a as described further herein with respect to FIGS. 13B and 14. These pipeline sleeves 104 may also be used with other pipeline configurations. For example, the pipeline sleeves 104 may be inserted into adjacent pipeline pipes 102 without a pipeline terminal 105 as described further herein (see, e.g., FIGS. 28A-28B).

As shown in the example of FIG. 6, the pipeline sleeve 104 is assembled by: providing an inner ring 220b at stage I; providing ring spacers 220c at stage II; and positioning the ring spacers 220c onto the inner ring 220b at stage III; providing the flex layer 220d at stage IV; applying the flex layer 220d onto the inner ring 220b and providing an outer ring 220a at stage V; positioning the outer ring 220a onto the inner ring 220b over the flex layer 220d and the ring spacers 220c and providing the sleeve liner 212b at stage VI; inserting the sleeve liner 212b into the inner ring 220b and providing the sleeve seals 204b at stage VII; and installing the sleeve seals 204b onto the sleeve liner 212b to form the completed pipeline sleeve 104 at stage VIII.

While a specific order and configuration of assembly of the pipeline sleeve 104 are shown, it will be appreciated that the order, positioning, structure, and assembly may vary. For example, the ring spacers 220c may be integrally formed with the inner ring 220b. Similar assembly techniques may be used to assemble the pipeline sleeves described herein (see, e.g., pipeline sleeve 404 (FIGS. 4C-4D), 704 (FIGS. 7-8B), and 1004 (FIGS. 10A-10C)).

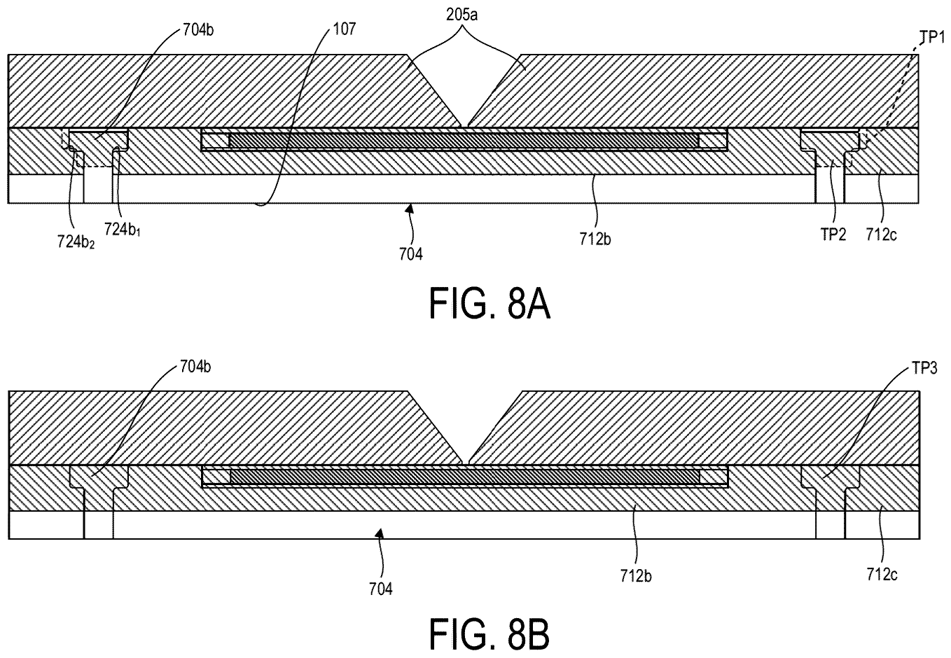

FIGS. 7, 8A-9B, and 9A-9D show another version of the pipeline sleeve 704 in a T-shaped seal configuration. FIG. 7 is a longitudinal, cross-sectional view of a portion of the pipeline 100 with another version of the pipeline sleeve 704 having the T-shaped sleeve seal 704b with a T-shaped configuration. FIGS. 8A-8B are longitudinal, cross-sectional views of a portion 8 of the pipeline 100 of FIG. 7 showing the pipeline sleeve 704 in an uncompressed and compressed position, respectively.

The pipeline sleeve 704 of these figures include the same components as the pipeline sleeve of FIGS. 2-4B, except that the sleeve seal 704b has changed to the T-shaped configuration. The sleeve liner 712b and the terminal liner 712c have also changed to conform to the shape of the T-shaped sleeve seal 704b.

As shown in FIGS. 7 and 8A and 8B, the T-shaped sleeve seal 704b is positioned between the sleeve liner 712b and the terminal liner 712c. In this version, the sleeve liner 712b is a distance from the terminal liner 712c such that the T-shaped sleeve seal 704b is exposed to fluid passing through the passage 107 and may expand into the passage 107. This version also provides the sleeve liner 712b with the seal pocket 724bl shaped to receive a portion of the T-shaped sleeve seal 704b. A mirror image of this seal pocket 724b2 is provided in the terminal liner 712c to receive a remaining portion of the T-shaped sleeve seal 704b.

FIGS. 8A and SB also show the T-shaped sleeve seal 704b as it changes shape during use. In FIG. 8A, T-shaped sleeve seal 704b is shown in the uninstalled position TP1 and the uncompressed position TP2. In the uninstalled position TP1, the T-shaped sleeve seal 704b has an elongated and wider shape. Once placed in the seal pockets 724bl, b2, the T-shaped sleeve seal 704b is pinched between the sleeve liner 712b and the terminal liner 712c and deforms to a narrower shape at position TP2.

As shown in FIG. 8B, when a pressure change occurs, the pipeline sleeve 104 is compressed and the T-shaped sleeve seal 704b deforms to the compressed position TP3. In the compressed position TP3, the T-shaped sleeve seals 704b fill the seal pockets 724bl, b2 and seals with the terminal tubes 205a. The T-shaped sleeve seals 704b may also be urged against the inner surface of the terminal tubes 205a.

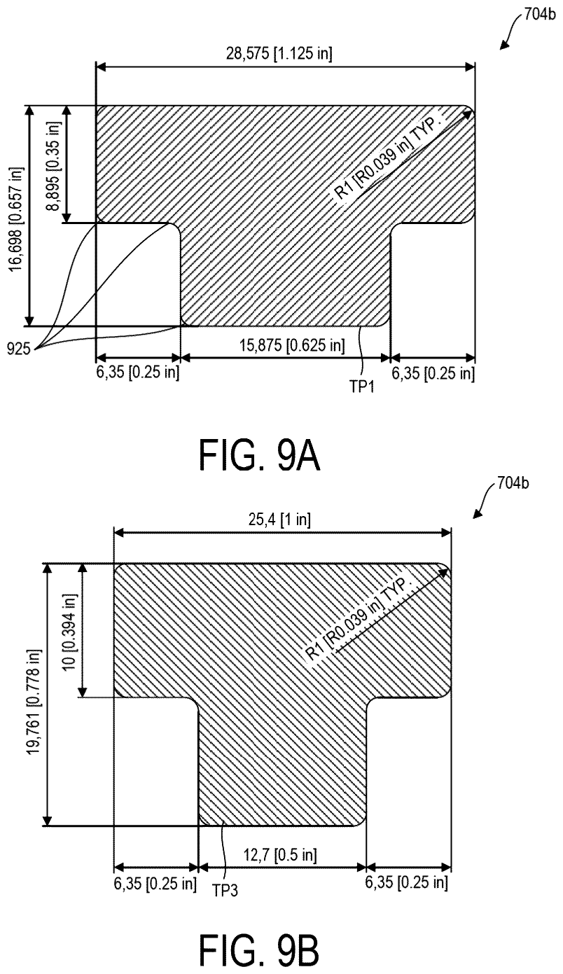

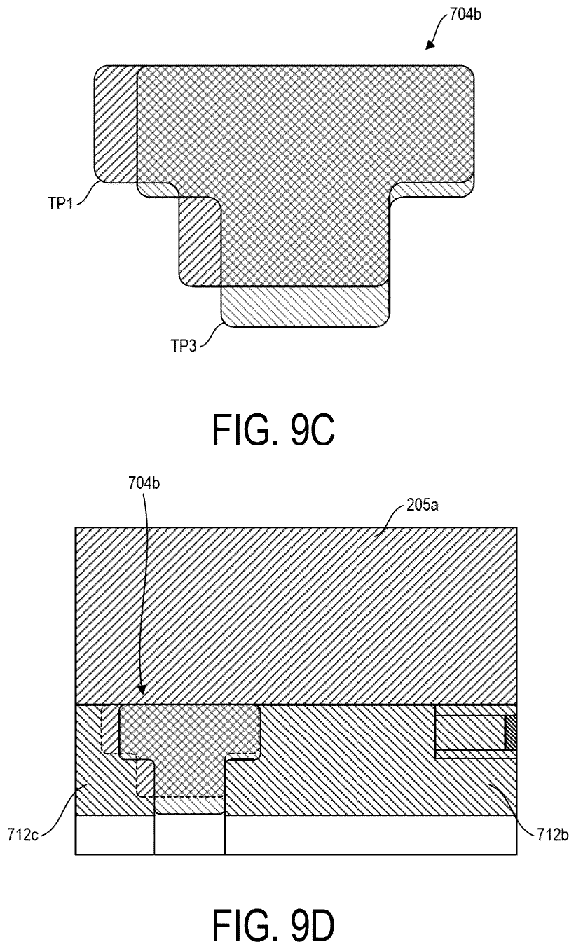

FIGS. 9A-9D are schematic diagrams showing various views of the T-shaped sleeve seal 704b. FIGS. 9A and 9B are cross-sectional views of the T-shaped sleeve seal 704b in an uninstalled position TP1 and compressed position TP3, respectively. FIG. 9C shows the T-shaped sleeve seal 704b of FIGS. 9A and 9B overlapped for comparison. FIG. 9D shows a portion 9 of the sleeve assembly of FIG. 7 with the overlapped T-shaped sleeve seals 704b of FIG. 9C.

As demonstrated by FIGS. 9A-9D, the T-shaped sleeve seals 704b are positioned about the pipeline sleeve 104 for sealing engagement with the terminal tubes 205a, the sleeve liner 712b, and the terminal liner 712c. These figures also show the T-shaped cross-section of the T-shaped sleeve seal 704b and with rounded corners 925. FIGS. 9A and 9B also show example dimensions that may be used with T-shaped sleeve seal 704b. It will be appreciated that any seal positionable about the pipeline sleeve 104 and sealable between the pipeline sleeve 104 and each of the pipeline pipes 102 may be used.

FIGS. 10A-10C are schematic diagrams depicting another version of the pipeline sleeve 1004 positioned in merged pipeline pipes 1002a,b. FIG. 10A shows a radial cross-sectional view of the pipeline 100 with the pipeline sleeve 1004 therein. FIG. 10B shows longitudinal, cross-sectional views of the pipeline 100 with the pipeline sleeve 1004 therein. FIG. 10C shows a longitudinal, cross-sectional view of the pipeline sleeve 1004 with the pipeline pipes 1002a,b removed.

As shown by FIGS. 10A-10C, the pipeline sleeve 1004 may have various configurations. In this example, the pipeline sleeve 1004 is positioned across adjacent pipeline pipes 1002a,b. The pipeline pipes 1002a,b are in an overlapped (merged) engagement configuration to demonstrate that adjacent pairs of the pipeline pipes 1002a,b (or pipeline terminals 105 if present) may be engaged in various ways. As also shown in this example, the pipeline terminals 105 are not required between the adjacent pairs of the pipeline pipes 1002a,b.

As shown in FIG. 10A, the pipeline pipes 1002a,b in this version may be conventional tubular metal pipes connected together by overlapping the pipeline pipes 1002a,b together. An end of a first pipeline pipe 1002a receives an end of a second, adjacent pipeline pipe 1002b therein. The second pipeline pipe 1002a may be inserted into the end of the first pipeline pipe 1002a by various means. The first pipeline pipe 1002a may have its end expanded or shaped to receive the adjacent end of the second pipeline pipe 1002b. The second pipeline pipe 1002b may also be compressed or shaped for insertion into the first pipeline pipe 1002a.

Once merged, an overlap 1031a may exist about the end of the first pipeline pipe 1002a and the second pipeline pipe 1002b. This overlap 1031a may be machined or modified as needed for use along the pipeline 100 (FIG. 1). Once merged, a gap 1031b may remain between the first and second pipeline pipes 1002a,b. The pipeline sleeve 1004 be positioned within, and extend across, both of the merged pipeline pipes 1002a,b about the overlap 1031a and the gap 1031b. The pipeline sleeve 1004 may also be configured to fill and/or seal the gap 1031b between the merged pipeline pipes 1002a,b.

As shown in FIGS. 10B and 10C, the pipeline sleeve 1004 may include similar components as the pipeline sleeve 104 of FIGS. 2-4B. In this version, the pipeline sleeve 1004 includes a different sleeve support 1004a, different sleeve sealers in the form of sleeve (tail) seals 1004b, and a different pipe liner 1012a. In this pipeline sleeve 1004, the sleeve support 1004a is shaped to conform to the merged pipeline pipes 1002a,b and the sleeve seals 1004b are in a tail seal configuration. Examples of other pipeline sleeves and tail sleeve seals that can be used are described in WO2022/031767 and WO2022/031769, previously incorporated by reference herein.

The sleeve support 1004a includes the ring spacers 220c as in the pipeline sleeve 104 of FIGS. 4A and 4B. The sleeve support 1004a also includes an outer ring 1020a with an outer surface 1023a, an inner ring 1020b, multiple flex layers 1020d1, 1020d2, an additional ring spacer 220c, and the sleeve liner 1012b. The outer ring 1020a is similar to the outer ring 220a of FIG. 4A, except that this version has an outer surface 1023a with a raised, offset, and asymmetrical peak 1023b. This peak 1023b is positioned along the outer surface 1023a of the outer ring 1020a at an offset location closer to one end of the pipeline sleeve 1004. This peak 1023b also has an asymmetrical (e.g., slanted) shape to conform to the gap 1031b between the pipeline pipes 1002a,b.

The inner ring 1020b is similar to the inner ring 220b of FIG. 4A. In this version, the inner ring I 020b is wider than the outer ring I 020a and is shaped to receive the sleeve seals 1004b thereon. The sleeve seals 1004b are supported between the inner ring 1020b and the pipeline pipes 1002a,b. The sleeve seals 1004b are also positioned between an end of the outer ring 1020a and the pipe liner 1012a. The pipe liner 1012a in this version extends from an end of the sleeve seals 1004b and into the pipeline pipes I 02. In this version, a liner is not provided along the sleeve, but may be included as desired.

The sleeve support 1004a includes three ring spacers 220c. Two of the ring spacers 220c are flush with the end of the outer ring 1020a as in the pipeline sleeve 104 of FIGS. 4A and 4B. The additional, third ring spacer 220c is positioned between the other two ring spacers 220c with the flex layers 1020d1,d2 therebetween.

The flex layers 1020d1,d2 are similar to the flex layer 220d of FIGS. 4A and 4B, but with different shapes to conform to the shape of the outer ring 1020a. The flex layer 1020d1 has rectangular ends shaped to fill the space 1024a between the ring spacers 220c and a flat portion of the outer ring 1020a. The flex layer 1020d2 also has a modified rectangular cross-section with a peak portion shaped to fill the space I 024b between the ring spacers 220c and a portion of the outer ring 1020a with the peak 1023b. The modified rectangular shape of the flex layer 1020d2 includes a raised, peripheral ridge 1023c corresponding to the peak 1023b.

While the figures herein describe specific configurations of the pipeline pipes, the pipeline terminal, and the pipeline sleeve, it will be appreciated that such configurations may vary. For example, various sleeve configurations may include various rings, layers, seals, spacers, and other features of the pipeline sleeve. In another example, the pipeline sleeve may be positioned in any configuration capable of extending the pipeline seal across the pair of adjacent pipeline terminals and/or pipeline pipes. The pipeline sleeve may also be in an external configuration positioned along an outer surface of the pipeline terminals of the pipeline pipes with the sleeve sealers (seals or gaskets) positioned between the pipeline sleeve and the pipeline terminals or pipeline pipes. In yet another example, any of the pipeline sleeves disclosed herein may be used in any connected pipeline pipes and/or pipeline terminals. One or more of the various components of the pipeline sealing assembly may be combined, and various of these components may be provided with of various dimensions, shapes, positions, and/or configurations. Examples of other variations and features that may be used are described in the patents/applications incorporated by reference herein.

FIGS. 11A-11E, 11F1-11F3, and 12A-12B show aspects of the pipeline terminal 105 (FIG. 2) in greater detail. FIGS. 11A-11E show various views of a belted liner 1142, including the terminal belt 205b and the terminal liner 212c. As shown by these views, the terminal belt 205b is positioned along an outer surface of the terminal liner 212c near an end of the terminal liner 212c. The terminal belt 205b may be mounted onto the terminal liner 212c by juxtaposition of two half-moon shapes, threading, or other methods (e.g., molding or injecting the material of the terminal liner 212c into the terminal belt 205b). Once the terminal belt 205b is mounted onto the terminal liner 212c, the combination is referred to as the belted liner 1142 as shown in FIG. 1 1D.

As shown in FIGS. 4A and 11A-11E, the terminal belt 205b may be a metal ring formed of a hardened material, such as steel. The outer surface of the terminal belt 205b may be shaped for sliding insertion into the terminal tube 205a. An inner surface of the terminal belt 205b may be shaped to grippingly engage an outer surface of the terminal liner 212c. The terminal belt 205b may also have multiple holes 1136b extending therethrough. For molded or injection construction, portions of the terminal liner 212c may extend through the holes 1136b and engage the inner surface of the terminal tubes 205a (see, e.g., 4A). The terminal belt 205b may be provided with raised ridges 1136a along its inner surface for gripping engagement with the terminal liner 212c. Channels 1136c are defined between the raised ridges 1136a. While ridges 1136a and channels 1136c are shown along the terminal belt 205b, other interference means, such as threads may also be used.

As shown in FIG. 11A, the terminal belt 205b is shaped to encircle, reinforce and support an end of the terminal liner 212c. The terminal liner 212c may have a stepped outer surface with a raised belt surface 1138a, and a raised rim 1138b at an end of the terminal liner 212c. In this example, the outer surface of the terminal liner 212c is smooth along the raised rim 1138b. The raised belt surface 1138a may be shaped to receive and support the terminal belt 205b thereon. The terminal belt 205b may be slidingly advanced onto the raised belt surface 1138a until it rests against the raised rim 1138b. The raised rim 1138b may terminate advancement of the terminal belt 205b.

As shown in FIGS. 11B-11E, the raised belt surface 1138a may include a set of raised bands 1140a with grooves 1140b therebetween. The raised bands 1140a and grooves 1140b may correspond to the raised ridges 1136a and the channels 1136c along the inner surface of the terminal belt 205b. The raised ridges 1136a are grippingly receivable in the grooves 1140b and the raised bands 1140a are receivable in the channels 1136c, thereby providing gripping engagement between the terminal liner 212c and the terminal belt 205b. The raised belt surface I 138a extends through the holes 1136b to contact the inner surface of the terminal tubes 205a. The raised belt surface 1138a may also restrict movement of the terminal liner 212c about the terminal belt 205b.

When installed into the terminal tubes 205a as shown in FIG. 4A, the belted liner 1142 is positioned against the inner surface of the terminal tubes 205a to secure and/or support the terminal liner 212c and the pipeline sleeve 104 in the terminal tubes 205a. The engagement end 218a of the terminal tube 205a may have an enlarged inner diameter shaped to receive the belted liner 1142. The difference in diameters between the engagement end 218a and the rest of the terminal tube 205a may define a terminal step 1121 along an inner surface of the pipeline terminal 105.

The terminal belt 205b is shaped for receipt along the inner surface of the terminal tube 205a and against the terminal step 1121 (FIG. 4A). As shown in FIG. 11B, the terminal belt 205b has a rounded end 1144a shaped to conform to the terminal step 1121 for receipt therein. The terminal belt 205b also has a flat end 1144b shaped to engage the raised rim 1138b of the terminal liner 212c.

FIGS. 1 IFI-11F3 show another version of portion 2 of the pipeline 100 (FIG. 2) and another version of the belted liner 1142′ in an interference fit configuration. Figure I IFI is a longitudinal, cross-sectional view of a portion of the pipeline with a constant diameter terminal tube 1105a and constant diameter belted liner 1142′. FIG. 11F2-11F3 are exploded and perspective views, respectively of the constant diameter belted liner 1142′.

As shown by FIG. 1 IFI, terminal tubes 1105a may be provided between the adjacent pipeline pipes 102, and support the pipeline sleeve 404 therein. The terminal tubes 1105a may be similar to the pipeline pipes 102, except that the terminal tubes 1105a have a constant outer diameter ODt similar to the outer diameter ODp of the pipeline pipes 102. The terminal tubes 1105a also have a constant inner diameter IDt similar to the inner diameter IDp of the pipeline pipes I 02. The constant inner diameter TDt of the terminal tubes 1105a no longer has the terminal step 1121 of FIG. 4A.

As shown in FIGS. 11F1-11F3, to conform to the constant inner diameter IDt of the terminal tubes 1105a, the belted liner 1142′ is also provided with a constant outer diameter. The outer diameter of the belted liner 1142′ may be shaped for an interference fit within the inner diameter IDt of the terminal tubes 1105a. This interference fit may allow the belted liner 1142′ to be shaped to secure and/or support the terminal liner 1112c along the inner surface of the terminal tubes 1105a.

The shape of the terminal liner 1112c may also be adjusted to support the terminal belt 205b against the constant inner diameter IDt of the terminal tube 1105a, and/or to support the pipeline sleeve 404 in the terminal tubes 1105a. The terminal liner 1112c narrows at one end to define a belt pocket 1138a′ shaped to receive the terminal belt 205b. This belt pocket 1138a′ may be recessed a distance below a remainder of the terminal liner 212c to allow an outer surface of the terminal belt 205b to be flush with an outer surface of the terminal liner 1112c and to conform to the inner surface of the terminal tube 1105a. Once in place within the terminal tubes 1105a, the belted liner 1142′ is urged against the inner surface of the terminal tubes 1105a and against the pipeline sleeve 404.

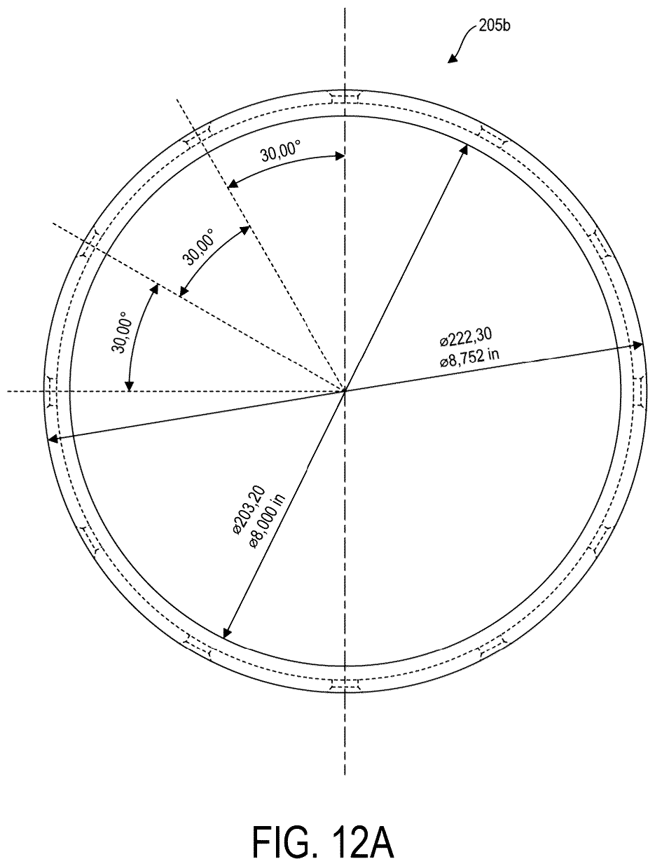

FIGS. 12A-12B are end and side views, respectively, of the terminal belt 205b. These figures show detailed views of the terminal belt 205b. These figures also include some example dimensions that may be used for the terminal belt 205b.

FIGS. 13A-13B and 14A-14B each show a process 1300a,b for assembling/pre-assembling portions the pipeline 100. FIGS. 13A and 13B are schematic perspective diagrams depicting stages of assembly A-L of the portions of the pipeline (e.g., 100 of FIG. 2). FIGS. 14A-14E are schematic cross-sectional diagrams depicting stages of assembly A-L of the portions of the pipeline 100. As shown by these views, these pipeline portions may be pre-assembled for delivery, or assembled on location.

FIGS. 13A and 14A show a process 1300a including stages A-I for assembling a pipe assembly 1350a,b. The pipe assembly 1350a to be assembled includes the pipeline pipe 102, the terminal tubes 205a, the pipe liner 212a, and the belted liner 1142 of FIG. 2. The process 1300a begins by first forming a tube assembly 1348a by: aligning a pipeline pipe 102 with a pair of terminal tube 205a at stage A, and matingly connecting (e.g., welding) the pair of terminal tubes 205a to the pipeline pipe 102 at stage B. Next, a liner assembly 1348b may be formed by: aligning a terminal liner 212c and a belted liner 1142 at stage C, and matingly connecting (e.g., welding, bonding, thermo-fusion, electro-fusion, etc.) the belted liner 1142 to the pipe liner 212a at stage D.

Next yet, the pipe assembly 1350a may be formed by: inserting the liner assembly 1348b into the tube assembly 1348a at stage E until the belted liner 1142 is positioned inside terminal tube 205a, extending the pipe liner 212a through an end of the tube assembly 1348a until the belted liner 1142 extends outside a distance from an end of the terminal tube 205a at stage F, aligning another belted liner 1142 with the extended pipe liner 212a at stage G, connecting the belted liner 1142 to the extended pipe liner 212a at stage H, and retracting the belted liner 1142 into the tube assembly 1348a to form the pipeline assembly 1350a at stage I.

The pipe assembly 1350a as shown in FIG. 13B includes a single pipeline pipe 102 connected to terminal tubes 205a at each end. It will be appreciated that the pipe assembly 1350a may include one or more pipeline pipes 102, and/or a terminal tube 205a at one or both ends of the pipeline pipe 102. In cases with multiple pipeline pipes 102, one or more pipe liners 212a may be positioned in the pipeline pipes 102. A version of the pipe assembly 1350a with multiple pipeline pipes 102 is referred to as the pipe assembly 1350b as shown in FIGS. 13B and 14B at stage J.

The pipe assembly 1350b is the same as the pipe assembly 1350a, except with multiple pipeline pipes 102 connected together between the terminal tubes 205a. This provides a pre-assembly of the pipeline pipe(s) 102 with the pipeline terminals 105 already thereon for delivery and/or use. These pipe assemblies 1350a,b may then be connected to portions of the pipeline 100 as shown by the pipe assembly 150 of FIG. 1.

Once pre-assembled, the pipe assembly 1350a may then be shipped, connected, and/or used. As shown in stages J-L of FIGS. 13B and 14B, the process 1300b may be performed to connect the pipe assembly 1350a to other pipe assemblies 1350a and/or pipeline sleeves 104 to form a portions 1350c of the pipeline 100.

The process 1300b includes: aligning a pipeline sleeve 104 between a pair of the pipe assemblies 1350a,b at stage J, inserting a portion of the pipeline sleeve 104 into a first of the pair of the pipe assemblies 1350a at stage K, and positioning a second of the pair of pipe assemblies 1350b onto the pipeline sleeve 104 and connecting (e.g., welding) the second of the pair of pipe assemblies 1350b to the first of the pair of pipe assemblies 1350a at stage L.

While a specific order and configuration of assembly of the pipeline sleeve 104 are shown, it will be appreciated that the order, positioning, structure, and assembly may vary. For example, as shown in stage J, the pipeline sleeve 104 may be pre-assembled as shown in FIG. 6 for installation in the pipe assembly/ies 1350a. In another example, the sleeve support 204a and the sleeve seals 204b may be provided separately and installed at stage J with the pipe assemblies 1350a,b. In yet another example, one or more of the terminal tubes 205a may be assembled with the pipeline pipes 102 and/or pipeline assemblies 1350a,b before, during, or after assembly of the other components. Techniques for assembly that may be used with portions of the processes 1300a,b are described in the patents/applications previously incorporated by reference herein.

One or more of the pre-assembled pipe assemblies 1350a,b may be connected in series to form the pipeline 100 as shown in FIG. 1. One or more of the pre-assembled pipe assemblies 1350a,b (or portions thereof) may be pre-assembled with other components used in pipelines. Examples of other components connectable to or usable with the pipeline pipes and the assemblies described herein are described in the patents/applications previously incorporated by reference herein. The pre-assembled pipe and/or pipeline assemblies described herein may also be connected with one or more other portions of the pipeline 100 (see, e.g., FIG. 1).

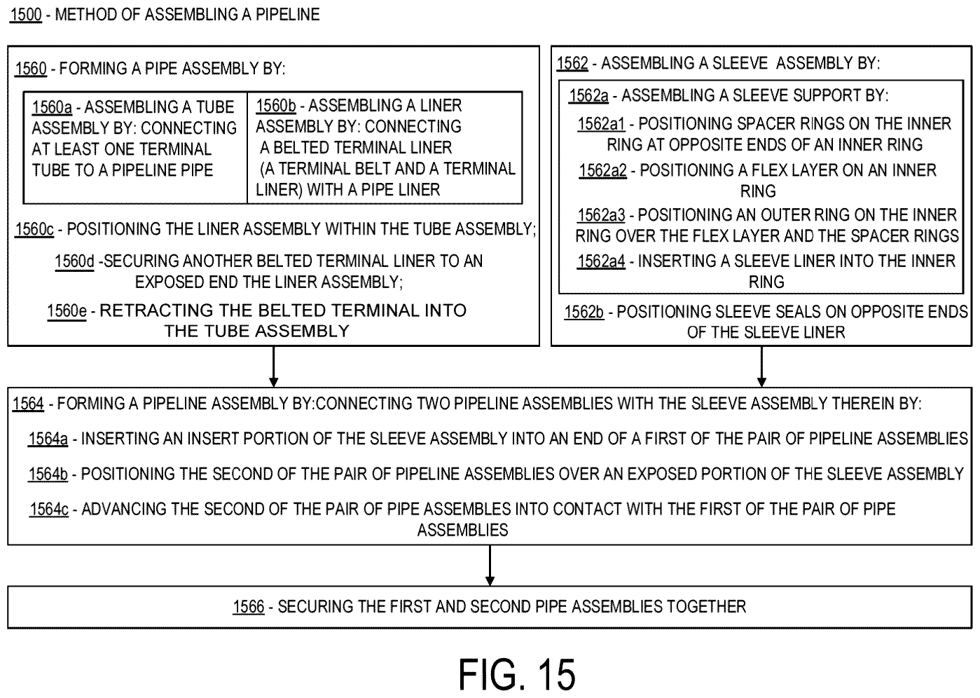

FIG. 15 shows an example method 1500 that may be performed in accordance with the disclosure. FIG. 15 is a flow chart depicting a method 1500 of assembling a pipeline 100. As shown in FIG. 15, the method may involve: (1560) forming a pipe assembly, (1562) assembling a sleeve assembly, (1564) forming a pipeline assembly by connecting two pipeline assemblies with the sleeve assembly therein, and (1566) securing the first and second pipe assemblies together.

The (1560) forming the pipe assembly may involve (1560a) assembling a tube assembly by: connecting at least one terminal tube to a pipeline pipe; and (1560b) assembling a liner assembly by: connecting a belted liner (a terminal belt and a terminal liner) with a pipe liner, (1560c) positioning the liner assembly within the tube assembly; (1560d) securing another belted liner to an exposed end of the liner assembly; and (1560e) retracting the belted liner into the tube assembly.

The (1562) assembling the sleeve assembly may be performed by: (1562a) assembling a sleeve support and (1562b). The (1562a) assembling may be performed by: (1562a1) positioning ring spacers on the inner ring at opposite ends of an inner ring; (1562a2) positioning a flex layer on an inner ring; (1562a3) positioning an outer ring on the inner ring over the flex layer and the ring spacers; and (1562a4) inserting a sleeve liner into the inner ring, and (1562B) positioning sleeve seals on opposite ends of the sleeve liner.

The (1564) forming may involve connecting two pipeline assemblies with the sleeve assembly therein by: (1564a) inserting an insert portion of the sleeve assembly into an end of a first of the pair of pipeline assemblies; (1564b) positioning the second of the pair of pipeline assemblies over an exposed portion of the sleeve assembly; (1564c) advancing the second of the pair of pipe assembles into contact with the first of the pair of pipe assemblies. The securing (1566) may involve welding, bonding, merging, or otherwise connecting the first and second pipe assemblies together.

The method of assembling a pipeline may also involve: sealingly connecting a pair of pipeline pipes together by: connecting a pipeline terminal to a pipe end of each of the pair of pipeline pipes; positioning connecting ends of the terminal tubes onto opposite ends of a pipeline sleeve; and connecting the connecting ends of the pipeline terminals together with the pipeline sleeve therein such that the pipeline sleeve forms a seal about the terminal ends.

The present disclosure also relates to a direct version of a pipeline sealing assembly for forming a seal about an adjacent and abutting pair of the pipeline pipes. This direct version of the pipeline sealing assembly is positioned between the abutting pair of the pipeline pipes without requiring additional terminal tubes between the abutting pair of pipeline pipes. This pipeline sealing assembly includes internal pipeline terminals and a pipeline sleeve. The internal pipeline terminals are positioned within the pipeline pipes. The pipeline sleeve is positioned between the internal pipeline terminals and across the abutting ends of the pair of pipeline pipes to form a seal therewith.

The internal pipeline terminals include the terminal liner with terminal belts secured at each end thereof to form an internal belted liner. The terminal belts may be positioned between the terminal liner and the pipeline sleeve and/or the pipeline to provide additional support, thereby assisting the pipeline sealing assembly in maintaining the pipeline seal. This configuration of the belted liner may also be used to enable the terminal liner along the inner surface of the pipeline pipe to expand evenly along the pipeline pipe.

The pipeline terminals and the pipeline sleeves have a mated sealing connection therebetween. Abutting ends of the pipeline sleeve end of the internal terminal may be shaped for sealing connection therebetween (e.g., with steps, inverted or reverse steps, tongues and grooves, etc.). One or more sleeve sealers (e.g., a-rings, gaskets, etc.) may be provided to facilitate sealing between the pipeline sleeve and the pipeline terminals.

The internal pipeline terminals may be locked into position against the inner surface of the pipeline pipes to lockingly line the pipeline pipes and/or to lockingly support the pipeline sleeve in a sealed position about the pipeline pipes. The internal pipeline terminals may be locked into position using various means, such as interference fit, compression, and/or fusion techniques. The direct pipeline assembly and one or more of its components (e.g., the internal pipeline terminals, the pipeline sleeve, etc.) may also be provided with one or more of the features and/or capabilities described herein.

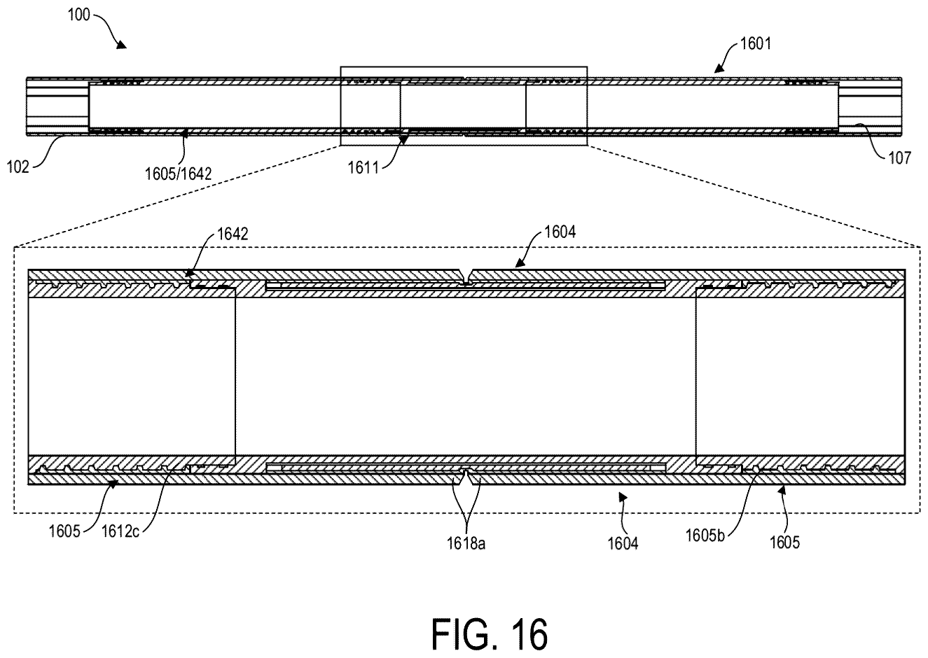

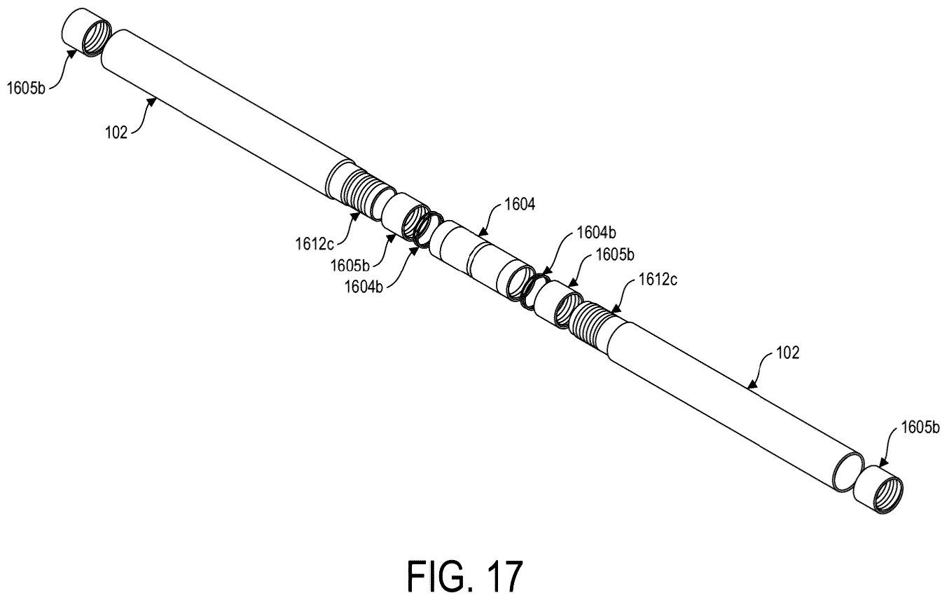

FIGS. 16-17 show a direct version of the pipeline sealing assembly 1601 positionable within the pipeline 100. FIG. 16 is a longitudinal, cross-sectional view another version of the pipeline sealing assembly 1601 in a direct configuration. FIG. 17 is an exploded view of the pipeline of FIG. 16. In this direct version, the pipeline sealing assembly 1601 is connected about adjacent pipeline pipes 102 without requiring pipeline terminals between the pipeline pipes 102 (see, e.g., pipeline terminals 105 of FIG. 2).

The pipeline sealing assembly 1601 includes the pair of internal pipeline terminals 1605 with the pipeline sleeve 1604 positioned within the abuttingly adjoined pipeline pipes 102 and between adjacent ends of the internal pipeline terminals 1605. The pipeline pipes 102 and the pipeline sealing assembly 1601 have constant internal diameters with the passage 107 extending therethrough. The passage 107 extends through each of the pipeline pipes 102, the internal pipeline terminals 1605, and the pipeline sleeve 1604 to permit substantially uninterrupted flow of fluid therethrough.

This direct version of the pipeline 100 is similar to the version shown in FIG. 2, except that the pipeline pipes 102 are connected directly together without a terminal tube 205 therebetween, and except that the pipeline sleeve 1604 and the internal (pipeline) terminals 1605 each has a different configuration. Each of the adjacent pipeline pipes 102 has an engagement end 1618a matingly connectable with the engagement end 1618a of an adjacent pipeline pipe 102. The engagement ends 1618a may be shaped for connection to the corresponding pipeline pipe 102. The engagement ends 1618a may be matingly connected (e.g., threaded, fitted, welded, etc.) to the adjacent pipeline pipe 102 in a similar manner as the terminal tubes 205 are connected together as described in FIGS. 2 and 4A-4B. The pipeline pipes 102 may be axially aligned such that the engagement ends 1618a align for engagement therebetween. As shown in FIG. 16, the engagement ends 1618a of adjacent pipeline pipes 102 may be beveled for abutting engagement and connection with each other.

While not shown, the engagement ends 1618a may also be provided with enlarged diameters for additional structural support and/or to facilitate connection. The engagement ends 1618a of the pipeline pipes 102 may be modified in a similar manner described with respect to the terminal tubes of FIG. 2. While the pipeline pipes are shown in abutting engagement, the pipeline pipes 102 may optionally be connected using butt strap or other methods, such as where the ends overlap as described further herein with respect to FIGS. 10A-10C.

The pipeline sleeve 1604 and the internal pipeline terminals 1605 are both positioned within the passage 107 and within the pipeline pipes 102. The pipeline sleeve 1604 is positioned in abutting engagement with the adjacent internal pipeline terminals 1605. The mated pipeline sleeve 1604 may be connected to the internal pipeline terminals 1605 to form a sealing connection with the sleeve sealers 1604b therebetween as is described further herein.

The internal pipeline terminal 1605 in this version may also be referred to as an internal belted liner 1642. The internal pipeline terminal 1605 supports the pipeline sleeve 104 in position while also providing protection from fluids flowing through the pipeline sleeve 104 in a similar manner as described in FIG. 2. The internal pipeline terminals 1605 may be similar to the pipeline terminals 105, except that the internal pipeline terminals 1605 each include a terminal liner 1612c and a terminal belt 1605b without the terminal tube 205a.

The terminal liner 1612c may be a tubular member similar to the liner 212 described in FIG. 2. The terminal liner 1612c may be shaped to conform to the inner surface of the pipeline pipes 102 with the passage 107 extending through the terminal liner 1612c. The terminal liner may also be shaped to receive the terminal belt 1605b.

The terminal belt 1605b may be a ring-shaped member positioned between the terminal liner 1612c and the pipeline pipes 102 to provide support as described further herein. The terminal liner 1612c may also be concentrically positioned within the pipeline pipes 102 and against the adjacent pipeline sleeve 1604. One or more terminal belts 1605b may be used. In the example shown, the terminal belt 1605b is positioned at each end of the terminal liner 1612c to support the terminal liner 1612c and the pipeline sleeve 1604 in the pipeline pipes 102. The terminal liner 1612c may be provided with an additional thickness to allow the terminal liner 1612c to expand evenly along the inner surface of the pipeline pipes 102 and/or to maintain a sealed and locked connection with the pipeline sleeve 1604 and the pipeline pipes 102. If additional support is needed, the terminal tubes 205a, additional terminal belts 1605b, and/or a thicker terminal liner 1612c may optionally be provided.

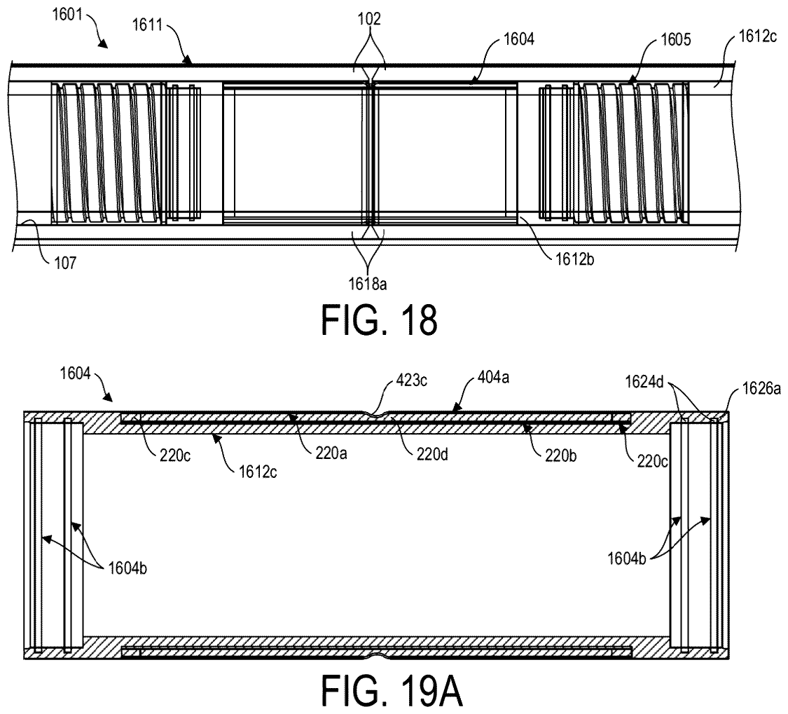

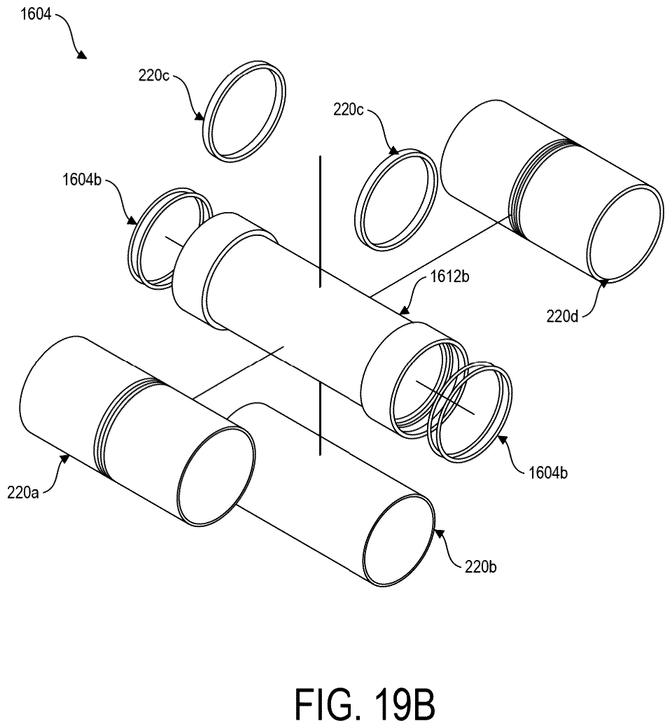

FIGS. 18-19B show another view of the pipeline sealing assembly 1601 showing the pipeline sleeve in greater detail. FIG. 18 is a longitudinal, cross-sectional view of the portion of the pipeline sealing assembly 1601. FIGS. 19A and 19B longitudinal, cross-sectional and exploded views, respectively, of the pipeline sleeve 1604 of the pipeline sealing assembly 1601. This pipeline sealing assembly 1601 includes an inverted step version of the pipeline sleeve 1604.

The pipeline sleeve 1604 may be similar to the gasket version of the pipeline sleeve 404 of FIGS. 4C and 4D, except that the pipeline sleeve 1604 has an inverted configuration shaped for matingly and sealing engagement between the internal pipeline terminal 1605 and the pipeline sleeve 1604. As shown in FIGS. 18-19B, the inverted step pipeline sleeve 1604 is a tubular member positioned in the passage 107 within the pipeline pipes 102. The pipeline sleeve 1604 may be axially aligned with the pipeline pipes 102 and concentrically positioned therein. The pipeline sleeve 1604 may be shaped to fit snugly within the pipeline pipes 102 to seal against the inner surface of the pipeline pipes 102. The pipeline sleeve 1604 may also extend across the adjoined engagement ends 1618a of the pipeline pipes 102 to form the pipeline seal 1611 thereabout.

The pipeline sleeve 1604 includes the sleeve support 404a, the sleeve liner 1612b, and the sleeve sealers 1604b. The sleeve support 404a includes the outer ring 220a, the inner ring 220b, the spacers 220c, and the flex layer 220d as previously described in FIGS. 4A and 4B. The sleeve support 404a is positioned in the pipeline sleeve 104 to support the pipeline sleeve 104 in the pipeline pipes 102 in a similar manner as described in FIGS. 4A and 4B.

In this example, the sleeve liner 1612b also has an inverted (or reverse) step 1626a shaped for connection with the terminal liner 1612c of the internal pipeline terminal 1605. Each of the inverted steps 1626a extends a distance from an end of the sleeve liner 1612b to receive an adjacent end of the terminal liner 1612c. The sealer pocket 1624d and the sleeve sealers 1604b have been repositioned along the inverted steps 1626a for sealing engagement with the adjacent ends of the terminal liner 1612c. As also shown in FIG. 19A, multiple sleeve sealers 1604b in the form of o-rings, gaskets, or other means of sealing and correspondingly shaped sleeve pockets may optionally be provided.

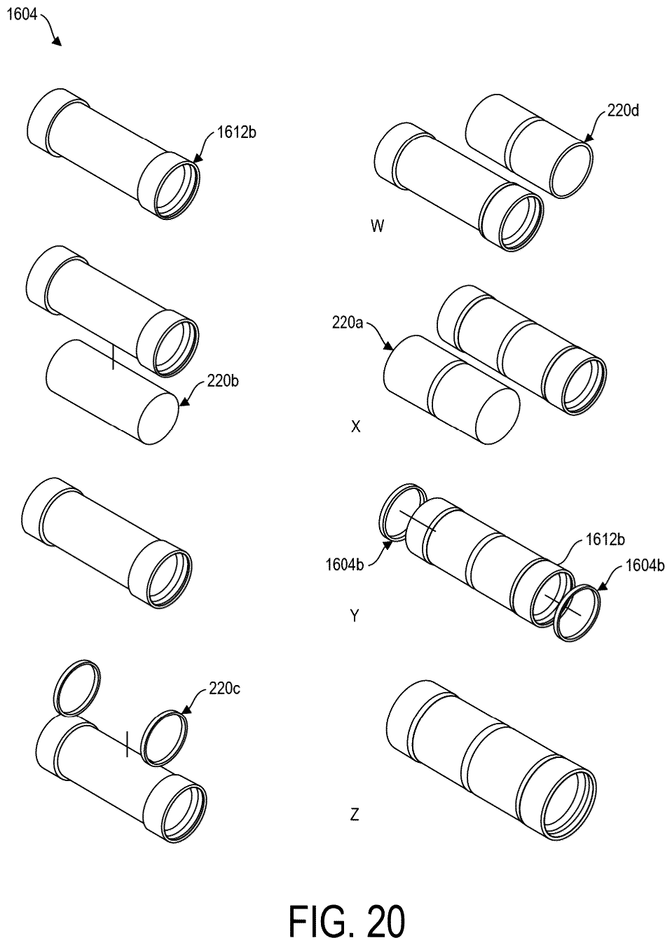

FIG. 20 is a schematic diagram depicting stages S-Z of assembly of the pipeline sleeve 1604 of FIG. 16. As demonstrated by FIG. 20, the pipeline sleeve 1604 may be pre-assembled for delivery or on location. The pre-assembled pipeline sleeve 1604 may then be inserted into the pipeline pipes 102 and connected to the internal pipeline terminals 1605 as described further herein with respect to FIG. 28B.

As shown in the example of FIG. 20, the pipeline sleeve 104 is assembled by: providing the sleeve liner 1612b at stage S; providing the inner ring 220b at stage T; inserting the sleeve liner 1612b into the inner ring 220b at stage U; providing the spacers 220c for insertion onto each end of the inner ring 220b at stage V; providing the flex layer 220d for application onto the inner ring 220b and the spacers 220c at stage W; providing the outer ring 220a for positioning onto the flex layer 220d at stage X; providing the sleeve sealers 1604b for insertion into the sleeve liner 1612b at stage Y; and installing the sleeve sealers 1604b into each end of the sleeve liner 1612b at stage Z.

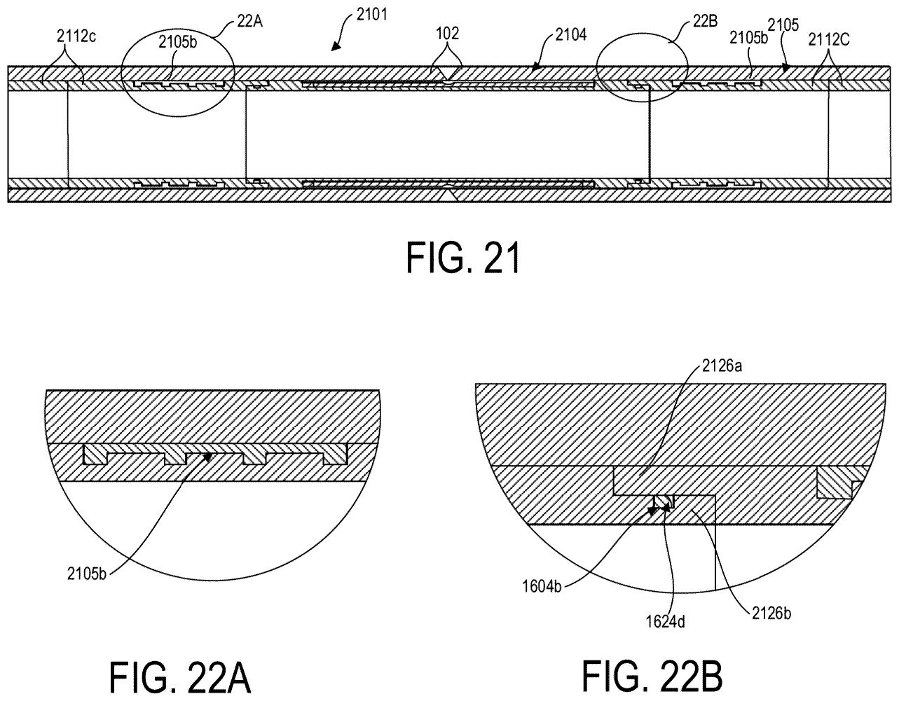

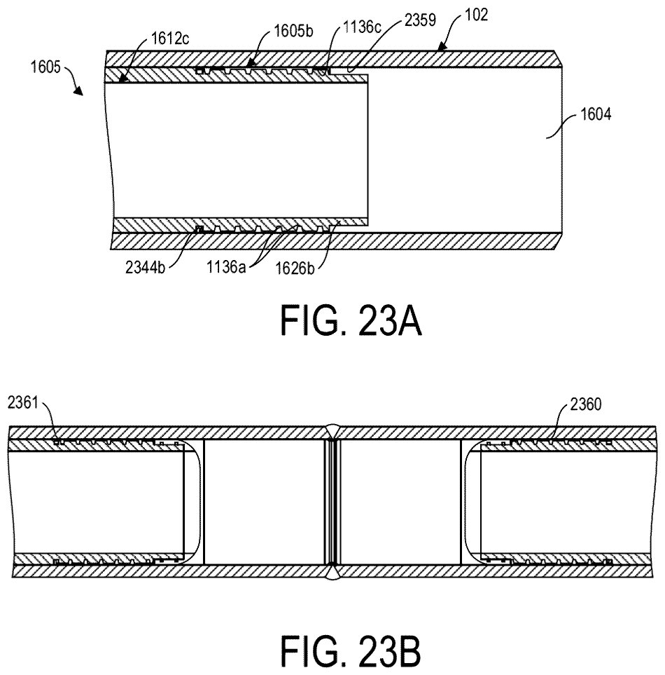

FIGS. 21-23B show another version of the pipeline sealing assembly 2101 having an upright sealing connection between the pipeline sleeve 2104 and the internal terminal 2105. FIG. 21 is a longitudinal, cross-sectional view of another version of the pipeline sealing assembly 210 1. FIGS. 22A and 22B are detailed views of portions 22A and 22B of the pipeline sealing assembly 2101 of FIG. 21. FIGS. 23A and 23B are longitudinal, cross-sectional, schematic views of portions of the pipeline sealing assembly 2101 of FIG. 21. As demonstrated by these views, the mated connection between the pipeline sleeve and the terminal sleeve may have various shapes to facilitate sealing therebetween.

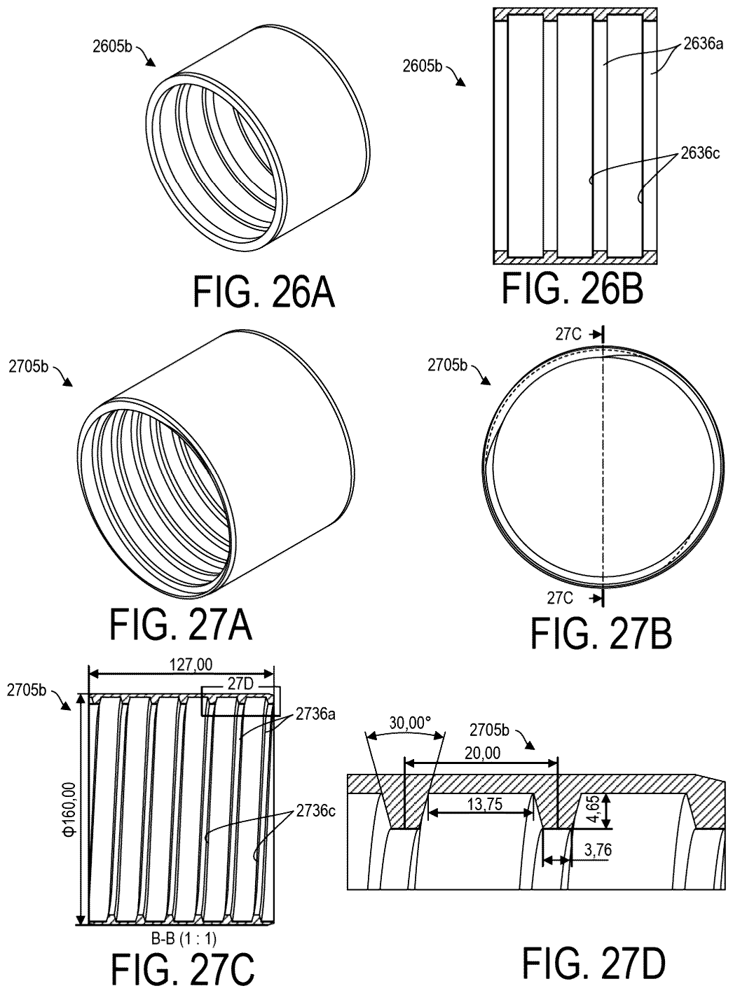

As shown in FIGS. 21-22B, the sealing connection between the pipeline sleeve 2104 and the internal terminal 2105 may vary. As shown in this example, the internal terminal 2105 may include multiple terminal liners 2112c connected together end to end and supported by the terminal belt 2605b. The terminal belt 2605b in this example is positioned a distance from the end of the terminal liner 2112c. The terminal belt 2605b in this example has a flat configuration as described further in FIGS. 26A-26B. The terminal belt 2605b may be applied to the terminal liner 2112c using, for example, a clamp. The terminal belt 2605b and the terminal liner 2112c may be formed by machining (e.g., cutting) or molding the terminal belt 2605b and the terminal liner 2112c to form the desired interconnection therebetween. The internal terminal 2105 may also be provided with one or more of the same features of the belted liners and/or pipeline terminals described herein.

As also shown in FIGS. 2 1-22B, the pipeline sleeve 2104 is sealingly engageable with the internal terminal 2105 along mated steps 2126a,b. In this example, the pipeline sleeve 2104 has sleeve steps 2126a similar to the sleeve steps 1626a of FIGS. 19A-19B, except that the sleeve steps 2126a and the corresponding liner steps 2126b have been inverted to provide an upright sealing connection similar to the sealing connection shown in FIGS. 4C and 4D.

The sleeve steps 2126a along each end of the pipeline sleeve 2104 define a receptacle 2304 between a terminal end of the pipeline sleeve 2104 and the pipeline pipe 102 shaped to receive the liner step 2126b of the terminal liner 2612c. The liner step 2126b of the terminal liner 2612c extends from a terminal end of the terminal liner 2612c for insertion into receptacle 2359 of the pipeline sleeve 2104. The sleeve sealer (e.g., a-ring) 1604b may be positioned along the sealer pocket 1624d and in the step 2126a of the pipeline sleeve 2104 to provide sealing engagement between the steps 2126a,b.

FIGS. 23A-25B show various aspects of the internal pipeline terminal 1605 of the pipeline sealing assembly 1601 of FIG. 16 in greater detail. The terminal liner 1612c may be similar to the terminal liner 412c and the terminal belt 1605b may be similar to the terminal belt 205b described in FIGS. 2 and 11A-11D. The terminal belt 1605b may be mounted onto the terminal liner 1612c in a similar manner as described in FIGS. 11A-11D to form the internal pipeline terminal 1605 (or belted liner 1642).

FIGS. 23A and 23B show additional views of the pipeline sealing assembly 1601 and the internal pipeline terminal 1605. As demonstrated by these views, the terminal belt 1605b may be configured to lock the terminal liner 1612c and/or the pipeline sleeve 1604 in position.

The terminal belt 1605b may be similar to the terminal belt 205b of FIGS. 1 1A-1 1D, except with a different shape. In this version, the terminal belt 1605 has additional channel ends 2344b and more channels 1136c and ridges 1136a. The channel ends 2344b define an opening between each of the terminal ends and a first of the ridges 1136a adjacent to the terminal ends of the terminal belt 1605b. The channel end 2344b adjacent the pipeline sleeve 2104 may sealingly engage with the terminal end of the sleeve step 1626a.

The terminal liner 2312c may have an outer connection surface 2360 shaped to receivingly engage the terminal belt 2605b. The outer connection surface 2360 may define a gap 2361 between the channel end 2344b and the outer connection surface 2360. As also shown in FIGS. 23A and 23B, when installed into the pipeline pipes 102, the internal pipeline terminal 1605 is positioned against the inner surface of the pipeline pipes 102 to secure and/or support the terminal liner 1612c and the pipeline sleeve 1604 in the pipeline pipes 102.

The internal terminal 2305 may be “locked” in place in the pipeline pipes 102. The internal pipeline terminal 1605 may be inserted into the pipeline pipe 102 such that a tight (locked) fit is achieved between the terminal belt 1605b and the inner surface of the pipeline pipe 102. Once locked in position the internal pipeline terminals 1605 may support and lock the terminal liner 1612c in position within the pipeline pipe 102, thereby also locking the pipeline sleeve 1604 between the internal pipeline terminals 1605 in place.

This locked fit or “belt locking” may be accomplished, for example, using an interference or a compression (expansion) technique. The interference technique involves providing a terminal belt 1605b having a larger outer diameter than an inner diameter of the pipeline pipe 102, thereby providing an interference fit when the terminal belt 1605b is inserted into the pipeline pipe 102.

The compression technique involves inserting the terminal belt 1605b (of any size) into the pipeline pipe 102 and applying compression along the inner surface of the terminal belt 1605b to expand the terminal belt 1605b and compress the terminal belt 1605b against the inner surface of the pipeline pipe 102. This compression may be applied using, for example, hydraulic compression. The compression may optionally be applied along the terminal liner 1612c to assert sufficient hydraulic force to expand, compress, and lock the terminal belt 1605b against the inner surface of the pipeline pipe 102. This compression may be applied such that the terminal belt 1605b plasticly deforms past its yield strength to maintain a locked position against the pipeline pipe 102. A fusion technique may also be used to weld the terminal liner 1612c to the pipe liner 212a (FIG. 2) by applying heat. This fusion technique may be performed by applying heat using, for example, electro-fusion or thermo-fusion. Examples of electro-fusing and/or thermo-fusing techniques are described in U.S. Pat. No. 4,176,274, NL6412575, U.S. Pat. Nos. 4,263,084, and 4,987,018. One or more belt locking techniques, such as those listed herein, may be used with any of the pipe assemblies described herein.

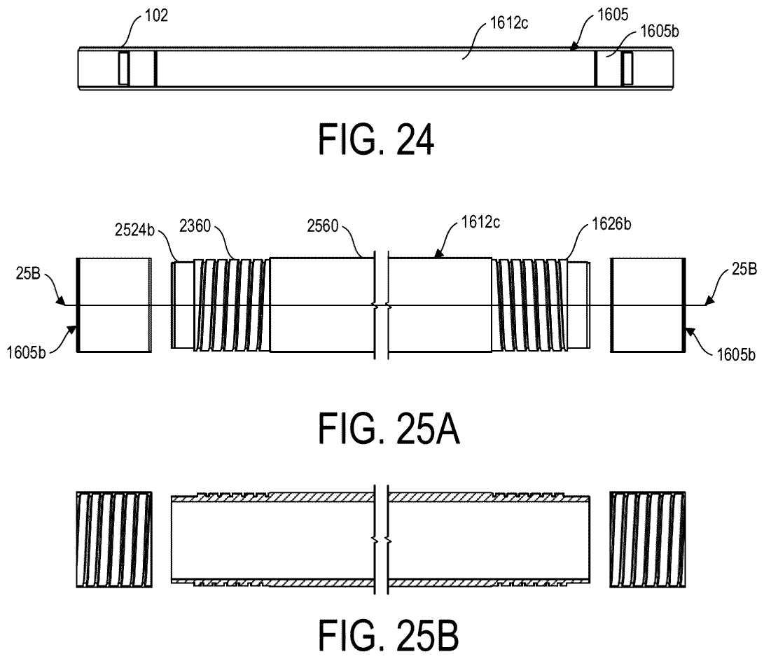

FIGS. 24-27D show a pitched version of the internal terminal 2405 in greater detail. FIG. 24 is a partial longitudinal, cross-sectional view of a pipeline pipe 102 with the internal pipeline terminal 1605 therein. FIGS. 25A and 25B are exploded perspective and cross-sectional views, respectively, of the internal terminal 2405. FIGS. 26A-26B are cross-sectional and perspective views, respectively, of an internal terminal belt 2605b with a flat configuration. FIGS. 27A-27D are various views of another internal terminal belt 2705b with a pitch configuration.

As shown in FIGS. 24 and 25A-25B, the terminal belts 1605b are positioned along an outer surface of the terminal liner 1612c near opposite ends of the terminal liner 1612c. The outer surface of the terminal liner 1612c is shaped to conform to the pipeline pipe 102, to receivingly support the terminal belts 1605b thereon, and to sealingly engage with the pipeline sleeve 1604 (FIG. 16). The outer surface includes a sealing surface 2560 and tapered ends 2524b. The sealing surface 2560 is positionable along the inner surface of the pipeline pipe 102. The outer diameter of the terminal liner 1612c along the sealing surface 2560 has a constant diameter shaped to conform to the inner surface of the pipeline pipe 102. The sealing surface 2560 is configured to lockingly engage the inner surface of the pipeline pipe 102 when placed under pressure as described further herein.

The tapered ends as 2524b have the connection surface 2360 thereon. The connection surface 2360 is shaped to receive the terminal belts 1605b thereon. The connection surface 2360 is shown having pitched threads shaped to matingly connect to the terminal belt 1605b. Other surfaces may also be provided along the terminal liner 1612c as shown, for example, in FIGS. 11A-11E.

The connection surface 2360 is positioned a distance from a terminal end of the tapered ends 2524b. The step 1626b is positioned along outer surface of the terminal liner 1612c between the terminal end and the connection surface 2360 for mating engagement with a corresponding sleeve step 1626a of a pipeline sleeve, such as pipeline sleeve 1604 of FIG. 19A. The terminal liner 2412c may be shaped to include various features to facilitation operation, such as the sealing surface 2560, the tapered ends, 2524b, the connection surface 2360, the step 1626b, etc. The terminal liner may be formed, for example, by machining or molding the terminal liner 2412c to include one or more such features.

As shown in FIGS. 26A-27D, the terminal belt 2605b,2705b may have various configurations to facilitate connection with the terminal liner (see, e.g., terminal liner 2112c of FIGS. 25A-25B). The terminal belts 2605b,2705b may be similar to the terminal belts described in FIGS. 1 1A-1 1F3, except with a different shape. The terminal belt 2605b of FIGS. 26A-26B has a flat configuration with channels 2636c and ridges 2636a shaped to conform to a mated terminal liner 1612c as shown in FIG. 22A. In this version, no holes 1136b are provided, fewer ridges 2636a and fewer channels 2636c are provided, and the outer surface of the terminal belt 2605b is flat.

The terminal belt 2705b may be similar to the terminal belt described herein (e.g., 2605b of FIGS. 26A-26B, 1605b of FIGS. 25A-25B, and 205b of FIGS. 11A-11F), except that this version has a pitch configuration. In this version, the ridges 2736a and the channels 2736c are pitched to provide threading engagement with the terminal liner (e.g., terminal liner 1612c of FIGS. 25A-25B). As shown in the detailed view of FIG. 27C, the inner surface of the terminal belt 2705b has tapered edges along the ridges 2736a and the channels 2736c at angles to facilitate threading with the terminal liner 1612c. The terminal liner 1612c has a corresponding shape for mated, threaded connection with the terminal belt 2705b. Example dimensions are also provided that may be used for the terminal belt 2705b.

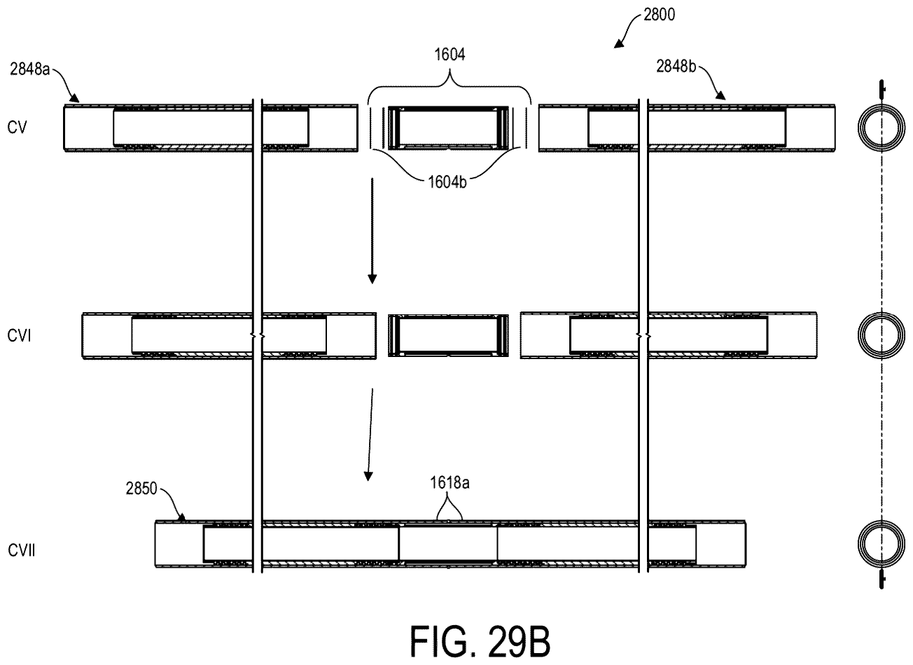

FIGS. 28A-28B and 29A-29B each show a process 2800 for assembling/pre-assembling portions the pipeline 100 to form a pipe assembly 2850. FIGS. 28A and 28B are schematic perspective diagrams depicting stages of assembly CI-CVII of the portions of the pipeline 100. FIGS. 29A-29E are schematic cross-sectional diagrams depicting stages of assembly CI-CVII of the portions of the pipeline 100. As shown by these views, these pipeline portions may be pre-assembled into the pipe assembly 2850 for delivery, or assembled on location.

In the example shown in FIGS. 28A-29B, the pipeline assembly 2850 includes features of the pipeline of FIGS. 16 and 17, including the terminal liner 1612c and the terminal belt 1605a, the pipeline sleeve 1604, and the pipeline pipe 102. The same process may be used with other pipeline assemblies described herein to provide a pre-assembly of portions of the pipeline assembly for delivery and/or use. These pipe assemblies 2850 may then be connected to portions of the pipeline 100 as shown by the pipe assembly 150 of FIG. 1.

The process 2800 begins by first forming a tube assembly 2848a by: inserting a portion of the terminal liner 1612c into the pipeline pipe 102 and aligning the terminal belt 1605b for insertion onto a first end of the terminal liner 1612c at stage CI, and matingly connecting (e.g., threading) the terminal belt 1605b onto the terminal liner 1612c at stage CII. Next, the terminal liner 1612c with the terminal belt 1605b thereon is advanced through the pipeline pipe 102 until an opposite end of the terminal liner 1612c extends a distance from the opposite end of the pipeline pipe 102 at stage CIII. Next, another terminal belt 1605b is aligned with and then matingly connected to the exposed end of the terminal liner 1612c at stage CIII, and the terminal liner 1612c with terminal belts 1605b at each end is retracted into the pipeline pipe 102 to form the tube assembly 2848a at stage CIV. Once inside the pipeline pipe 102, pressure may be applied to expand and lock the terminal liner 1612c to an inner surface of the pipeline pipe 102. This process may be repeated to form a second tube assembly 2848b.

The process 2800 continues by: aligning the pipeline sleeve 1604 between adjacent ends of the preassembled tube assemblies 2848a,b at stage CV. The pipeline sleeve 1604 may be pre-assembled as shown in FIG. 19B with or without the sleeve sealers 1604b during this alignment. The sleeve sealers 1604b may be inserted into the pipeline sleeve 1604 at stage CVI. Next, a first end of the pipeline sleeve 1604 may be inserted into the first tube assembly 2848a and a second end of the pipeline sleeve 1604 may be inserted into the second tube assembly 2848b, and the pipeline pipes 102 advanced together until the engagement ends 1618a of the pipeline pipes 102 are in contact to form the pipe assembly 2850 at stage CVII. The pipeline pipes 102 may then be adjoined by welding or other means.

The pipe assembly 2850a as shown in FIGS. 28B and 29B includes a pair of pipeline pipes 102 with a pipeline sealing assembly 1601 therein. It will be appreciated that the pipe assembly 2850a may include one or more pipeline pipes 102 and/or a terminal tube 205a at one or both ends of the pipeline pipe 102. In cases with multiple pipeline pipes 102, one or more pipeline sleeves 1604 may be positioned in the pipeline pipes 102. Once pre-assembled, the pipe assembly 2850a may then be shipped, connected, and/or used. As shown in stages J-L of FIGS. 13B and 14B, the pipe assembly 2850a may be connected to other to pipe assemblies to form portions of the pipeline 100.

Part or all of the methods described herein may be repeated. For example, multiple pipeline assemblies may be secured together to form the pipeline 100 (FIG. 1). Part or all of the techniques may be performed at various locations. Portions of the method may be performed in various orders, and part or all may be repeated. Other methods may be used as part of or with the methods described herein, such as those described in the patents previously incorporated herein.

The pipeline assemblies herein may be provided with various shapes, configurations, features and options, such as those described herein including, but not limited to raised hump or channel of the pipeline sleeve, raised portions of the pipeline liner, sealing mechanisms, components, sleeve sealers, configurations of pipeline sleeves, pipeline liners, and pipeline terminals as described further herein, and sealing techniques and features found in the patents/applications previously incorporated by reference herein.

While the figures herein describe specific configurations of the pipeline pipes, the pipeline terminals, and the pipeline sleeves, and other features herein, it will be appreciated that such configurations may vary. For example, it will be appreciated that the order, positioning, structure, and assembly may vary.

This description of preferred embodiments is to be read in connection with the accompanying drawings, which are part of the entire written description of this invention. In the description, corresponding reference numbers are used throughout to identify the same or functionally similar elements. Relative terms such as “horizontal,” “vertical,” “up,” “upper”, “down,” “lower”, “top”, “bottom”, “anterior” and “posterior” as well as derivatives thereof (e.g., “horizontally,” “downwardly,” “upwardly,” etc.) should be construed to refer to the orientation as then described or as shown in the drawing figure under discussion. These relative terms are for convenience of description and are not intended to require a particular orientation unless specifically stated as such. Terms including “inwardly” versus “outwardly,” “longitudinal” versus “lateral” and the like are to be interpreted relative to one another or relative to an axis of elongation, or an axis or center of rotation, as appropriate. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise. The term “operatively connected” is such an attachment, coupling or connection that allows the pertinent structures to operate as intended by virtue of that relationship.

While the embodiments are described with reference to various implementations and exploitations, it will be understood that these embodiments are illustrative and that the scope of the inventive subject matter is not limited to them. Many variations, modifications, additions and improvements are possible. For example, various combinations of one or more of the features and/or methods provided herein may be used.

Plural instances may be provided for components, operations or structures described herein as a single instance. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter. For example, while certain connectors are provided herein, it will be appreciated that various forms of connection may be provided. While the figures herein depict a specific configuration or orientation, these may vary. First and second are not intended to limit the number or order.

What is claimed is:

1. A pipeline assembly for forming a seal about a pipeline, the pipeline having pipeline pipes connected together with a passage to receive fluids therethrough, the pipeline assembly comprising:
a pipeline sleeve positionable in the passage of the pipeline to form a pipeline seal therewith, the pipeline sleeve comprising:
a sleeve support having tubular shape with an outer sleeve surface shaped to conform to an inner pipeline surface of the pipeline;
a sleeve liner positionable in the passage of the pipeline, the sleeve liner having a tubular shape, the sleeve liner having an outer liner surface with a sleeve pocket extending therein, the sleeve pocket shaped to receivingly support the sleeve support, a portion of the outer liner surface of the sleeve liner sealingly engageable with the inner pipeline surface of the pipeline, the sleeve liner having sealing ends on each end thereof; and
pipeline terminals, each of the pipeline terminals comprising:
a terminal liner positionable in the passage of the pipeline, the terminal liner having a tubular shape with an outer terminal surface engageable with the inner pipeline surface of the pipeline, the terminal liner having a sleeve end and an open end, the sleeve end sealingly engageable with the sealing end of the sleeve liner; and
a terminal belt positioned about the terminal liner, the terminal belt lockably secured into position between the outer terminal surface of the terminal liner and the inner pipeline surface of the pipeline whereby the pipeline sleeve is lockingly and sealingly secured about the pipeline pipes.

2. The pipeline sleeve of claim 1, wherein the pipeline sleeve is positioned about adjacent ends of a pipe pair of the pipeline pipes to form a seal thereabout.

3. The pipeline sleeve of claim 1, wherein each of the pipeline terminals further comprise a terminal tube, each of the terminal tubes connectable between a pipe pair of the pipeline pipes, and wherein the pipeline sleeve is positioned about adjacent ends of a terminal pair of the terminal tubes to form a seal thereabout.

4. The pipeline sleeve of claim 3, wherein an inner tube surface of the terminal tube has a terminal recess extending therein, the terminal recess shaped to receivingly support the terminal belt.

5. The pipeline sleeve of claim 1, wherein the pipeline sleeve further comprises sleeve sealers, each of the sleeve sealers positioned about each end of the pipeline sleeve, the sleeve sealers sealingly engageable with the sleeve end of the terminal liner.

6. The pipeline sleeve of claim 5, wherein the sleeve sealers comprise at least one of an o-ring, a gasket, and combinations thereof.

7. The pipeline sleeve of claim 5, wherein each of the sleeve sealers comprises a T-shaped seal positioned between the sleeve liner and the terminal liner.

8. The pipeline sleeve as in claim 5, wherein the sleeve liner has a pocket at each of the sleeve ends shaped to receivingly support the sleeve sealers.

9. The pipeline sleeve as in claim 1, wherein the sleeve liner has sleeve steps and the terminal liner has a terminal step, each of the sleeve steps matingly engageable with a corresponding one of the terminal steps.

10. The pipeline sleeve of claim 1, wherein the sleeve support comprises: an inner sleeve, an outer sleeve, ring spacers, and a flex layer, the flex layer and the ring spacers positioned between the inner sleeve and the outer sleeve.

11. The pipeline sleeve of claim 1, wherein the terminal belt has an outer diameter greater than an inner diameter of the pipeline pipes and wherein the terminal belt is lockably fit against the inner pipeline surface of the pipeline pipes.

12. The pipeline sleeve of claim 1, wherein the terminal belt is lockably compressed against the inner pipeline surface of the pipeline pipes.

13. The pipeline sleeve of claim 1, wherein the open end of the terminal liner is welded to a pipeline liner in the pipeline pipe by one of electro-fusing and thermo-fusing.

14. A method of forming a pipeline assembly, comprising:
assembling a first loaded pipeline pipe by:
a) positioning a terminal belt about a terminal liner to form a belted liner;
b) inserting the belted liner into a pipeline pipe;
assembling a second loaded pipeline pipe by repeating a)-b);
inserting a first sleeve end of a pipeline sleeve into a first contact end of the first loaded pipeline pipes;
inserting a second sleeve end of the pipeline sleeve into a second contact end of the second loaded pipeline pipe; and
connecting the first contact end of the first loaded pipeline pipe to the second contact end of the second loaded pipeline pipe.

15. The method of claim 14, further comprising sealingly engaging the first sleeve end of the pipeline sleeve with the terminal liner in the first loaded pipeline pipe and sealingly engaging the second sleeve end of the pipeline sleeve with the terminal liner in the second loaded pipeline pipe.

16. The method of claim 14, further comprising locking the terminal belt into at least one of the first loaded pipeline pipe and the second loaded pipeline pipe by compressing the terminal belt along an inner pipeline surface of the at least one of the first loaded pipeline pipe and the second loaded pipeline pipe.

17. The method of claim 14, wherein the terminal belt has an outer diameter larger than an inner diameter of at least one of the first loaded pipeline pipe and the second loaded pipeline pipe and wherein the method further comprises locking the terminal belt into the at least one of the first loaded pipeline pipe and the second loaded pipeline pipe by inserting the terminal belt into the at least one of the first loaded pipeline pipe and the second loaded pipeline pipe such that an interference fit is provided therein.

18. The method of claim 14, further comprising locking the terminal liner in one of the first and second loaded pipeline pipes by welding the terminal liner to a pipeline liner by one of electro-fusing and thermo-fusing.

19. The method of claim 14, further comprising forming a sealing surface along an outer liner surface of the terminal liner, the sealing surface shaped to matingly receive the terminal belt.

20. The method of claim 14, further comprising forming a locked pipeline connection by applying sut1icient pressure to compress the terminal belt and secure the pipeline sleeve in the first and second loaded pipeline pipes.

21. The method of claim 14, further comprising forming the pipeline sleeve by:
positioning a sleeve liner in an inner tube;
positioning spacers about an outer tube surface of the inner tube;
applying a flexible layer to the outer tube surface of the inner tube between the spacers;
positioning an outer tube about the flexible layer and the spacers; and
positioning sleeve sealers about each of the first sleeve end and the second sleeve end of the sleeve liner.

22. A method of assembling a pipeline, comprising:
assembling a pipeline assembly by:
a) assembling a tube assembly by connecting terminal tubes to a first pipeline end and a second pipeline end of a pipeline pipe;
b) assembling a liner assembly by:
assembling a belted liner by connecting a terminal belt to a first liner end of a terminal liner;
inserting a first belted end of the belted liner into the first pipeline end of the pipeline pipe and advancing the liner assembly into the pipeline pipe until a second belted end of the belted liner extends from the second pipeline end of the pipeline pipe;
connecting a second terminal belt to a second liner end of the belted liner; and
retracting the belted liner into the pipeline pipe;
forming another pipeline assembly by repeating a) and b);
inserting a first portion of a pipeline sleeve into the first pipeline end of a first of the pipeline pipes and inserting a second portion of the pipeline sleeve into the second pipeline end of a second of the pipeline pipes; and
connecting the first pipeline end of the first of the pipeline pipes and the second pipeline end of the second pipeline pipe.
